(19) United States
(12) Patent Application Publication
(10) Pub. No.: US 2019/0173566 A1
(43) Pub. Date: Jun. 6, 2019

(54) WIRELESS COMMUNICATION DEVICE AND WIRELESS COMMUNICATION METHOD

(71) Applicant: KABUSHIKI KAISHA TOSHIBA, Tokyo (JP)

(72) Inventors: Tomoya TANDAI, Tokyo (JP); Daiki YODA, Yokohama (JP); Daisuke UCHIDA, Kawasaki (JP); Koji AKITA, Yokohama (JP)

(73) Assignee: KABUSHIKI KAISHA TOSHIBA, Tokyo (JP)

(21) Appl. No.: 15/916,944

(22) Filed: Mar. 9, 2018

(30) Foreign Application Priority Data
Jun. 12, 2017 (JP) 2017-115443

(51) Int. Cl. H04B 7/155

(52) U.S. Cl. CPC H04B 7/15571

(57) ABSTRACT

According to one embodiment, a wireless communication device includes a first receiver; a second transmitter; a controller; and a pre-equalizer. The controller switches a reception frequency of the first receiver from a first frequency to a second frequency and a transmission frequency of the first transmitter from the second frequency to the first frequency, at a first timing. The pre-equalizer pre-equalizes a second signal, based on channel state information of a first signal received in the first receiver before the first timing. The first transmitter transmits the pre-equalized second signal, after the first timing.

### CROSS REFERENCE TO RELATED APPLICATIONS

This application is based upon and claims the benefit of priority from the prior Japanese Patent Application No. 2017-115443, filed on Jun. 12, 2017, the entire contents of which are incorporated herein by reference.

### FIELD

Embodiments described herein relate to a wireless communication device and a wireless communication method.

### BACKGROUND

A wireless relay device (referred to as a relay device, hereinafter) is a wireless communication device that relays radio waves when a reaching distance of the radio waves is limited due to limitation of transmission power or attenuation or interference of the radio waves or the like. The relay device once receives the radio waves, performs signal amplification or the like, and then retransmits the radio waves.

In the case where transmission processing and reception processing are simultaneously performed in the relay device, when carrier frequencies of transmission signals and reception signals are the same, signals transmitted from the relay device are received by the device, and occurrence of sneak path interference that a circuit oscillates becomes a problem. Further, in the case where the same carrier frequency is used in a channel of the respective relay devices with each other, a channel between the relay device and a portable station and a channel between the relay device and a base station, interference waves are generated mutually between the different channels, and degradation of communication quality becomes unneglectable.

### BRIEF DESCRIPTION OF THE DRAWINGS

FIG. 1 is a block diagram of a wireless relay device as a wireless communication device according to a first embodiment;

FIG. 2 is a diagram illustrating examples of a wireless relay network according to the first embodiment;

FIG. 3 is a diagram time-sequentially illustrating changeover processing of a carrier frequency of the wireless relay device according to the first embodiment;

FIG. 4 is a diagram time-sequentially illustrating a relation between a physical arrangement and the carrier frequency of the wireless relay device according to the first embodiment;

FIG. 5 is a diagram time-sequentially illustrating the changeover processing of the carrier frequency of the wireless relay device according to a first modification of the first embodiment;

FIG. 6 is a diagram time-sequentially illustrating a relation between a physical arrangement and a utilization frequency of the plurality of wireless relay devices for the first modification of the first embodiment;

FIG. 7 is a diagram illustrating a range of synchronizing timings of carrier frequency changeover in the wireless relay network using the wireless relay device;

FIG. 8 is a functional block diagram of the wireless relay device as the wireless communication device according to a second embodiment;

FIG. 9 is a diagram illustrating a format of a frame transmitted by the wireless relay device according to the second embodiment;

FIG. 10A is a diagram illustrating processing performed to the frame by the wireless relay device according to the second embodiment;

FIG. 10B is a diagram illustrating processing performed to the frame by the wireless relay device according to the second embodiment;

FIG. 11A is a diagram illustrating processing performed to the frame by the wireless relay device according to a first modification of the second embodiment;

FIG. 11B is a diagram illustrating processing performed to the frame by the wireless relay device according to the first modification of the second embodiment;

FIG. 12 is a functional block diagram of the wireless relay device as the wireless communication device according to a third embodiment;

FIG. 13 is a diagram illustrating a format of the frame transmitted by the wireless relay device according to the third embodiment;

FIG. 14A is diagram illustrating processing performed to the frame by the wireless relay device according to the third embodiment;

FIG. 14B is a diagram illustrating processing performed to the frame by the wireless relay device according to the third embodiment;

FIG. 15A is a diagram illustrating processing performed to the frame by the wireless relay device according to a first modification of the third embodiment;

FIG. 15B is a diagram illustrating processing performed to the frame by the wireless relay device according to the first modification of the third embodiment;

FIG. 16 is a functional block diagram of the wireless relay device as the wireless communication device according to a fourth embodiment;

FIG. 17 is a diagram illustrating a format of the frame transmitted by the wireless relay device according to the fourth embodiment;

FIG. 18A is diagram illustrating processing performed to the frame by the wireless relay device according to the fourth embodiment;

FIG. 18B is a diagram illustrating processing performed to the frame by the wireless relay device according to the fourth embodiment;

FIG. 19 is a diagram illustrating a format of the frame transmitted by the wireless relay device according to the fifth embodiment;

FIG. 20A is diagram illustrating processing performed to the frame by the wireless relay device according to the fifth embodiment;

FIG. 20B is a diagram illustrating processing performed to the frame by the wireless relay device according to the fifth embodiment;

FIG. 21 is a functional block diagram of the wireless relay device as the wireless communication device according to a sixth embodiment;

FIG. 22 is a diagram illustrating an example of a wireless relay network connecting the wireless relay device according to the sixth embodiment and a base station; and

FIG. 23 is a functional block diagram of the wireless relay device as the wireless communication device according to a seventh embodiment.

### DETAILED DESCRIPTION

According to one embodiment, a wireless communication device includes a first receiver; a second transmitter; a controller; and a pre-equalizer. The controller switches a reception frequency of the first receiver from a first frequency to a second frequency and a transmission frequency of the first transmitter from the second frequency to the first frequency, at a first timing. The pre-equalizer pre-equalizes a second signal, based on channel state information of a first signal received in the first receiver before the first timing. The first transmitter transmits the pre-equalized second signal, after the first timing.

Hereinafter, embodiments of the present invention will be described with reference to the drawings. In addition, for same components in the drawings, identical numbers are attached and description is appropriately omitted.

### First Embodiment

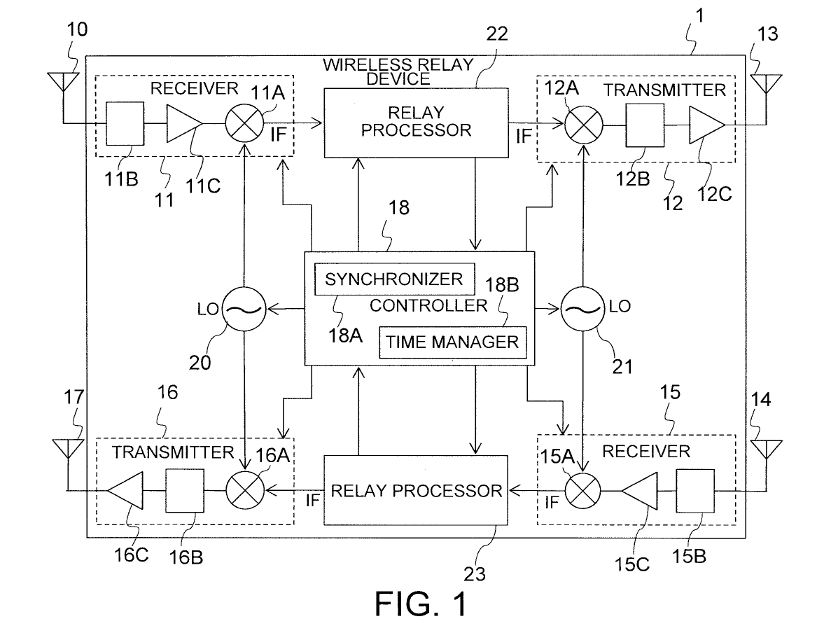

FIG. 1 is a block diagram illustrating an example of a wireless relay Device (relay device, hereinafter) as a wireless communication device according to the present embodiment. A relay device 1 includes an antenna 10, an antenna 13, an antenna 14 and an antenna 17. The antenna 10 is arranged so as to receive signals from a first direction. The antenna 13 is arranged so as to transmit signals in a second direction. The antenna 14 is arranged so as to receive signals from the second direction. The antenna 17 is arranged so as to transmit signals in the first direction. Sizes and shapes of the antenna 10, the antenna 13, the antenna 14 and the antenna 17 are not limited in particular. For example, the antenna may be a parabola antenna or an array antenna for which each antenna is configured from a plurality of antenna elements or the like. The first direction and the second direction here mean respectively different directions in a view from the relay device 1. An angle between the first direction and the second direction is not limited in particular. The relay device 1 further includes a receiver 11 electrically connected with the antenna 10, a transmitter 12 electrically connected with the antenna 13, a receiver 15 electrically connected with the antenna 14, and a transmitter 16 electrically connected with the antenna 17. By the electric connection, radio waves received by the antenna 10 are delivered to the receiver 11 as electric signals. By the electric connection, the antenna 13 can transmit the electric signals outputted by the transmitter 12 as the radio waves. Similarly, the radio waves received by the antenna 14 are delivered to the receiver 15 as the electric signals. Similarly, the antenna 17 can transmit the electric signals outputted by the transmitter 16 as the radio waves. A same single antenna may be shared for the antenna 10 and the antenna 17. In addition, a same single antenna may be shared for the antenna 13 and the antenna 14. In at least either case, a duplexer is inserted, though not illustrated, between the shared antenna and the receiver and the transmitter.

The relay device 1 further includes a controller 18, a local oscillator 20, a local oscillator 21, a relay processor 22 and a relay processor 23 as components. The controller 18 controls and monitors the receiver 11, the transmitter 12, the receiver 15, the transmitter 16, the local oscillator 20, the local oscillator 21, the relay processor 22 and the relay processor 23. In addition, the controller 18 includes a synchronizer 18A and a time manager 18B. All or part of the transmitter 12, the transmitter 16, the receiver 11, the receiver 15, the controller 18, the local oscillator 20, the local oscillator 21, the relay processor 22 and the relay processor 23 may be realized by software by making a processor such as a CPU execute a program, may be realized by an exclusive hardware circuit or a programmable circuit, or may be realized by both.

The synchronizer 18A of the controller 18 is in charge of a function of synchronizing a timing at which the controller 18 performs frequency changeover for a transmission frequency which is a frequency of the radio wave used for transmission, a reception frequency which is a frequency of the radio wave used for reception or both of the transmission frequency and the reception frequency, with another relay device or a terminal device (the terminal device is also one form of the wireless communication device) which mutually performs the transmission and the reception with the relay device 1. Hereinafter, when changeover of a carrier frequency is described, all the cases of the changeover of only the transmission frequency, the changeover of only the reception frequency and the changeover of both transmission frequency and reception frequency are included. As a communicator used for synchronizing a carrier frequency changeover timing, a data transmission/reception function that the receiver 11, the transmitter 12, the receiver 15 and the transmitter 16 have may be used, a wireless communication function provided by the other component may be used, or a wired electric telecommunication line may be used.

The time manager 18B is in charge of a time management function of the controller 18. The time manager 18B may include a real-time clock or a timer for time management. The time management function includes each processing of management of the present time, measurement of elapsed time and time adjustment. The frequency changeover timing of the controller 18 is measured based on the time provided by the time manager 18B as an example. In order to guarantee accuracy of the time of the time manager 18B, the time may be synchronized with an external server using a Network Time Protocol (NTP), or a standard radio wave transmitted by a standard frequency station may be received and synchronization may be performed with the time. In order to communicate with the external server and a terminal, the controller 18 may use a data communication function of the receiver 11, the transmitter 12, the receiver 15 and the transmitter 16, or may use the electric telecommunication line separately provided for management. The electric telecommunication line for management may be wired or wireless, and a communication protocol to be used is not limited in particular. An implementation of the time manager may be by hardware, by software, or by a combination of both hardware and software.

As a method of matching the carrier frequency changeover timing of the relay device 1 with another relay device or a terminal device, there is a method of synchronizing all the time of the relay device or the terminal device which is a carrier frequency changeover target using the synchronizer 18A and the time manager 18B of the controller 18 described above and then executing the frequency changeover at the specified time. When this method is used, at the specified time or cycle, the changeover of the transmission frequency and the reception frequency of the relay device and the terminal device which are the frequency changeover targets is simultaneously performed. In addition, there is a method of detecting a frame boundary by acquiring synchronization of a reception frame as described later and performing the frequency changeover with detection of the frame boundary as a trigger. The above methods of synchronizing the timing of performing the frequency changeover are just examples, and the method is not limited to either method in particular. Further, the frequency changeover target may be both of the reception frequency and the transmission frequency, or may be one of the reception frequency and the transmission frequency.

The receiver 11 includes a mixer 11A, a filter 11B, and an amplifier 11C. Similarly, the receiver 15 includes a mixer 15A, a filter 15B, and an amplifier 15C. The filter 11B and the filter 15B are band-pass filters which pass only a frequency band of a reception target. When the frequency of the reception target changes, the frequency band to pass is changeable. For a purpose of noise elimination or the like, another filter such as a low-pass filter may be further added to the receiver 11 and the receiver 15. The amplifier 11C and the amplifier 15C have a function of amplifying the electric signal for frequency conversion or processing in the relay processor 22 or the relay processor 23. Even though only one amplifier is illustrated respectively in the receiver 11 and the receiver 15 in FIG. 1, the amplifier may be further added as needed. A function and a configuration of the mixer 11A and the mixer 15A will be described later.

The transmitter 12 includes a mixer 12A, a filter 12B, and an amplifier 12C. Similarly, the transmitter 16 includes a mixer 16A, a filter 16B, and an amplifier 16C. The filter 12B and the filter 16B are band-pass filters which pass only the electric signal of a transmission frequency band. For a purpose of noise elimination or the like, another filter such as a low-pass filter may be further added also to the transmitter 12 and the transmitter 16. The amplifier 12C and the amplifier 16C have a function of amplifying the electric signal to transmission power. The amplifier may be the one of a multistage structure. In addition, a configuration with an increased number of the amplifiers may be used as needed. The function and the configuration of the mixer 12A and the mixer 16A will be described later.

The local oscillator 20 and the local oscillator 21 generate signals for the frequency conversion used when converting each reception frequency to an intermediate frequency in the receiver 11 or the receiver 15. The signals for the frequency conversion generated by the local oscillator 20 and the local oscillator 21 are also used when converting the signals of the intermediate frequency to the signals of the transmission frequency in the transmitter 12 or the transmitter 16. As the local oscillator 20 and the local oscillator 21, there are various implementations such as a synthesizer by a Phase Locked Loop (PLL) or a Direct Digital Synthesizer (DDS), but a system to be used is not limited in particular. In addition, two or more times of the frequency conversion may be used such as double conversion or triple conversion. Furthermore, in the case where the local oscillator 20 and the local oscillator 21 can be integrated by the combination of the reception frequency used in the receiver 11 and the receiver 15 and the transmission frequency used in the transmitter 12 and the transmitter 16, the configuration of using only one local oscillator may be used. Conversely, the configuration with a further increased number of the local oscillators is not excluded either.

The signals generated by the local oscillator 20 are used for converting the electric signals of the reception frequency of the receiver 11 to the intermediate frequency used in the relay processor 22, in the mixer 11A. Further, the signals generated by the local oscillator 20 are used for converting the electric signals of the intermediate frequency outputted from the relay processor 23 to the transmission frequency of the transmitter 12, in the mixer 16A of the transmitter 16. In the mixer 11A and the mixer 16A, the frequency conversion is realized by taking out the signals of a frequency which is a sum or a difference of mixed frequencies.

The signals generated by the local oscillator 21 are used for converting the electric signals of the intermediate frequency outputted from the relay processor 22 to the transmission frequency of the transmitter 12, in the mixer 12A of the transmitter 12. Further, the signals generated by the local oscillator 21 are used for converting the electric signals of the reception frequency of the receiver 15 to the intermediate frequency used in the relay processor 23. Also in the mixer 12A and the mixer 15A, the frequency conversion is realized by taking out the signals of the frequency which is the sum or the difference of the mixed frequencies. For the mixer, there are a plurality of circuit configurations using various parts such as a diode, a transistor or an integrated circuit, but an mounting method is not limited in particular.

The controller 18 can issue a command of changing a reception frequency fₜ₁ of the antenna 10 and the receiver 11, a transmission frequency fₜ₁ of the antenna 13 and the transmitter 12, a reception frequency fᵣ₂ of the antenna 14 and the receiver 15, and a transmission frequency fₜ₂ of the antenna 17 and the transmitter 16, an intermediate frequency fᵢ₁ of the relay processor 22 and an intermediate frequency fᵢ₂ of the relay processor 23. A frequency change command can be issued for all the frequencies or issued for only some of the frequencies. Specific frequency change processing is executed by changing an oscillation frequency of the local oscillator 20 and changing an oscillation frequency of the local oscillator 21.

The relay processor 22 performs equalization processing (channel equalization or pre-equalizing or both) to the electric signals received by the antenna 10 and converted to the intermediate frequency in the receiver 11. Thus, the signals for relay are sent to the transmitter 12 in the state that a data transmission characteristic of the signals is improved. In the transmitter 12, the frequency conversion, amplification and transmission by the antenna 13 are performed. Similarly, the relay processor 23 performs the equalization processing (channel equalization or pre-equalizing or both) to the electric signals received by the antenna 14 and converted to the intermediate frequency in the receiver 15. Thus, the signals for relay are sent to the transmitter 16 in the state that the data transmission characteristic of the signals is improved. In the transmitter 16, the frequency conversion, the amplification and the transmission by the antenna 17 are performed. The components inside the relay processor 22 and the relay processor 23 and detailed processing performed therein will be described later.

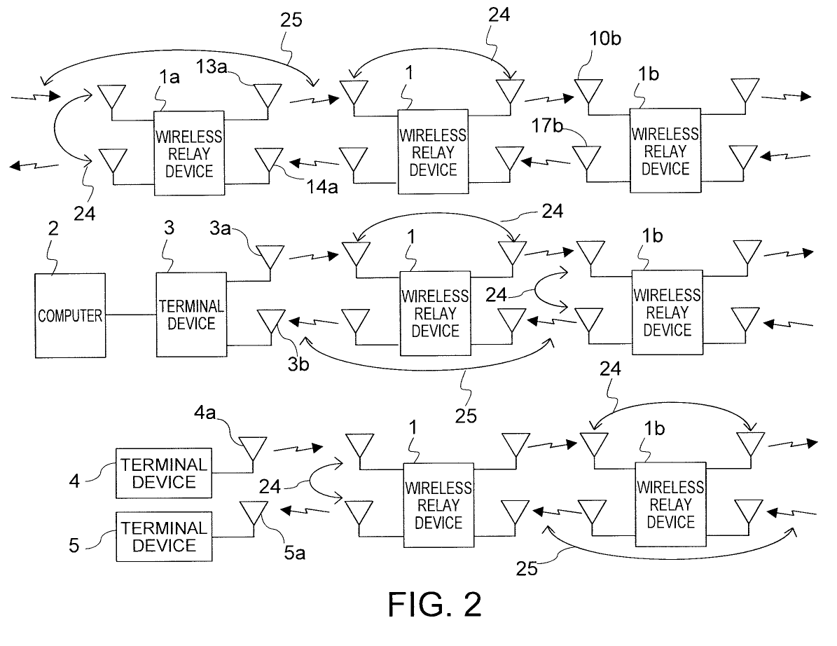

FIG. 2 illustrates three examples of a wireless relay network using the relay device of the present embodiment. In an upper stage of FIG. 2, the wireless relay network in which a relay device 1a, the relay device 1 and a relay device 1b are used and the three relay devices are arranged successively is illustrated as an example. The relay device 1a includes an antenna 13a which transmits the radio waves to the relay device 1, and an antenna 14a which receives the radio waves from the relay device 1. The relay device 1b includes an antenna 17b which transmits the radio waves to the relay device 1, and an antenna 10b which receives the radio waves from the relay device 1. The number of the successive relay devices is not limited to three and may be two, four or more. By arranging the relay devices at every interval determined in consideration of a range of the radio waves used in communication in this way, periodical signal amplification and improvement of the transmission characteristic are repeated, and data communication can be performed at remote locations with each other. When the radio waves reach, the radio waves can be relayed by only one relay device without successively arranging the plurality of relay devices.

In a middle stage of the FIG. 2, the wireless relay network in which the relay device 1 relays the radio waves transmitted and received by a terminal device 3 which is a wireless communication device to the relay device 1b is illustrated as an example. The terminal device 3 includes an antenna 3a which transmits the radio waves to the relay device 1, and an antenna 3b which receives the radio waves from the relay device 1. The radio waves transmitted and received by the terminal device 3 carries data inputted or outputted by a computer 2. An example of uses of the computer 2 is a server for management/control of the wireless relay network. The configuration is just an example, and the wireless relay network in which a connection destination of the terminal device 3 is not one computer but another device or a combination of other devices may be constructed.

In a lower stage of FIG. 2, the wireless relay network in which the relay device 1 relays the radio waves transmitted by a terminal device 4 which is the wireless communication device and the radio waves received by a terminal device 5 which is the wireless communication device to the relay device 1b or from the relay device 1b is illustrated as an example. The terminal device 4 includes an antenna 4a which transmits the radio waves to the relay device 1. The terminal device 5 includes an antenna 5a which receives the radio waves transmitted from the relay device 1. In this way, the number of the terminal devices that the relay device 1 faces is not limited to one and may be two or more.

By constructing the wireless relay network as described above, large-capacity information transmission can be realized while solving a problem of a limited reaching distance of the radio waves. In a millimeter wave region, since an effect of attenuation by vapor and gaseous molecules is strongly shown as a frequency becomes higher, a demand for solving the problem of the attenuation of the radio waves is high and a need of constructing a system using the relay device is high. In addition, since the limitation of the transmission power exists also in regions other than the millimeter wave region, the information transmission of a distance longer than the reaching distance of the radio waves can be realized using the wireless relay network as described above, also in the wireless communication using other frequency bands.

In the case of configuring the wireless relay network as described above, when the transmission frequency and the reception frequency are set to the same frequency, various problems arise. In the case where the radio waves are simultaneously transmitted and received, the signals transmitted from the relay device are received by the device, and sneak path interference that a circuit oscillates may occur. FIG. 2 illustrates a combination 24 of the antennas with a risk of occurrence of the sneak path interference as described above as an example. Further, when the same carrier frequency is used in a plurality of channels in the wireless relay network, interference waves not only between the antennas but also between the channels are generated, and communication quality may be deteriorated. FIG. 2 illustrates a combination 25 of the channels with a risk of generation of such interference waves as an example.

Then, in the relay device in the embodiment of the present invention, processing of switching the transmission frequency and the reception frequency with each other by the time is performed so that channel information in the transmission frequency can be estimated from the signals received before the most recent frequency changeover time. By performing pre-equalizing using the estimated channel information, the communication quality of the signals to be relayed is improved. It is not needed to perform a sounding process beforehand in order to acquire the channel information in the transmission frequency from the signals received before the most recent frequency changeover time, and processing loads on the relay device are reduced as well.

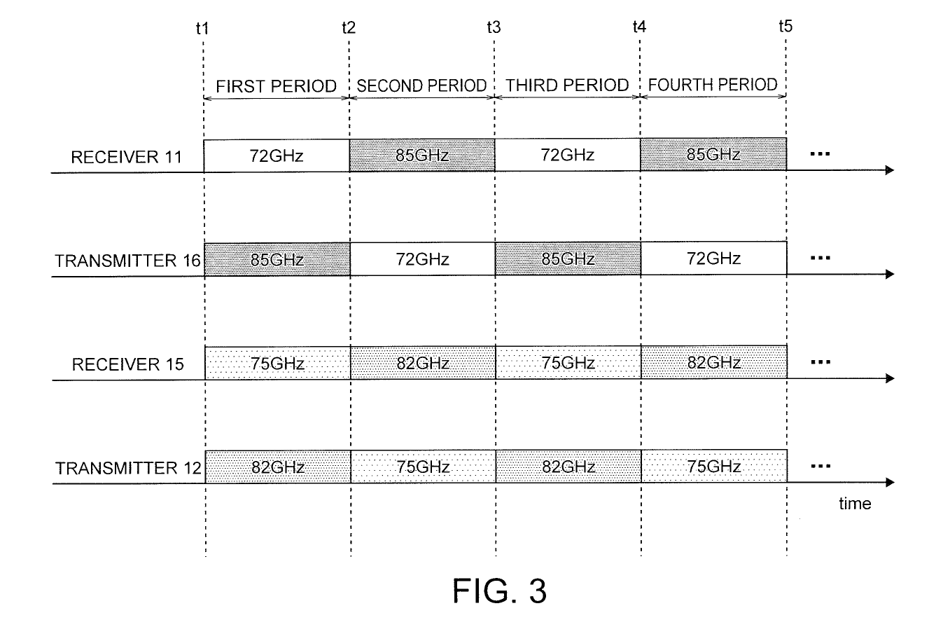

FIG. 3 illustrates an example that the respective parts of the relay device time-sequentially perform processing of switching the frequency used in data transmission/reception. A horizontal axis expresses time “t” and it is assumed that the time advances from left to right. In FIG. 3, changeover processing of the carrier frequency is performed at the respective timings time-sequentially in an order of the times t1, t2, t3, t4, and t5. A first period indicates a period between the time t1 and the time t2. A second period indicates a period between the time t2 and the time t3. A third period indicates a period between the time t3 and the time t4. A fourth period indicates a period between the time t4 and the time t5. Hereinafter, details of the processing at the timing at which the frequency is switched will be described.

At the time t1, the controller 18 sets the reception frequency of the receiver 11 to 72 GHz. Thus, the receiver 11 can receive the radio waves at the frequency 72 GHz by the antenna 10. Further, the controller 18 sets the transmission frequency of the transmitter 12 to 82 GHz. Thus, the transmitter 12 can frequency-convert the signals received in the receiver 11 to 82 GHz and transmit the signals from the antenna 13. At the same time t1, the controller 18 sets the reception frequency of the receiver 15 to 75 GHz. Thus, the receiver 15 can receive the radio waves at the frequency 75 GHz by the antenna 14. Further, the controller 18 sets the transmission frequency of the transmitter 16 to 85 GHz. Thus, the transmitter 16 can frequency-convert the signals received in the receiver 15 to 85 GHz and transmit the signals from the antenna 17.

At the time t1, since 82 GHz and 85 GHz which are the frequencies used in the data transmission are different from 72 GHz and 75 GHz which are the frequencies used in the data reception, even when the data are transmitted and received at the same time, occurrence of the sneak path interference within the same relay device can be suppressed. Further, since the frequencies for the transmission are separated into 82 GHz and 85 GHz and the frequencies for the reception are separated into 72 GHz and 75 GHz respectively, occurrence of interference between channels can be also suppressed.

At the time t2, the controller 18 sets the reception frequency of the receiver 11 to 85 GHz. Thus, the receiver 11 can receive the radio waves at the frequency 85 GHz by the antenna 10. Further, the controller 18 sets the transmission frequency of the transmitter 12 to 75 GHz. Thus, the transmitter 12 can frequency-convert the signals received in the receiver 11 to 75 GHz and transmit the signals from the antenna 13. At the same time t2, the controller 18 sets the reception frequency of the receiver 15 to 82 GHz. Thus, the receiver 15 can receive the radio waves at the frequency 82 GHz by the antenna 14. Further, the controller 18 sets the transmission frequency of the transmitter 16 to 72 GHz. Thus, the transmitter 16 can frequency-convert the signals received in the receiver 15 to 72 GHz and transmit the signals from the antenna 17.

The transmission frequency 75 GHz set to the transmitter 12 at the time t2 is the same as the reception frequency 75 GHz set to the receiver 15 at the time t1. Further, the transmission frequency 72 GHz set to the transmitter 16 at the time t2 is the same as the reception frequency 72 GHz set to the receiver 11 at the time t1. Since the reception frequency before the carrier frequency changeover is equal to the transmission frequency after the carrier frequency changeover, transmission channel state information can be estimated from reception channel state information acquired before the carrier frequency changeover timing.

The reception channel state information is information indicating a state of a channel from the other device to the present device, and the transmission channel state information is information indicating a state of a channel from the present device to the other device. The reception channel state information can be expressed by a channel matrix formed of components for the number of pieces of a value for which the number of transmission antennas of the other device and the number of reception antennas of the present device are multiplied for example. Each element includes an amplitude variation amount and phase rotation of the pertinent channel as the information. When symmetry of the channel is assumed, the transmission channel state can be calculated from the reception channel state. For example, when the number of the transmission antennas of the other device and the number of the reception antennas of the present device are the same, the reception channel state information can be considered as being identical to the transmission channel state information.

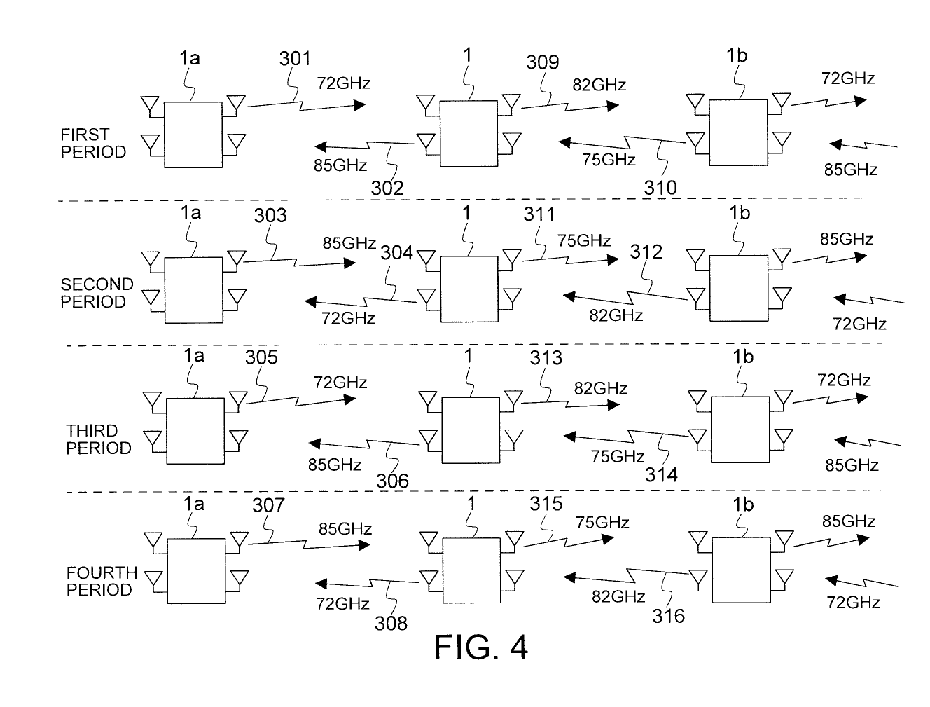

FIG. 4 is a diagram time-sequentially illustrating a relation between a physical arrangement and the carrier frequency of the plurality of relay devices. It is assumed that the time advances from the first period in the order of the second period, the third period and the fourth period. During each period, the changeover processing of the carrier frequency is performed. Next, the processing in each period will be described. While it is expressed that the signals of the reception frequency are converted to the signals of the transmission frequency in the description, the description is omitted for the conversion from the reception frequency to an intermediate frequency and conversion from the intermediate frequency to the transmission frequency performed in the middle of the conversion.

In the first period, the relay device 1 receives a signal 301 of 72 GHz transmitted from the relay device 1a. The relay device 1 converts the signal 301 to the transmission frequency 82 GHz, and transmits the signal to the relay device 1b as a signal 309 of 82 GHz. Further, the relay device 1 receives a signal 310 of 75 GHz transmitted from the relay device 1b. The relay device 1 converts the signal 310 to the transmission frequency 85 GHz, and transmits the signal to the relay device 1a as a signal 302 of 85 GHz.

In the second period, the relay device 1 receives a signal 303 of 85 GHz transmitted from the relay device 1a. The relay device 1 converts the signal 303 to the transmission frequency 75 GHz, and transmits the signal to the relay device 1b as a signal 311 of 75 GHz. The frequency 75 GHz of the signal 311 is equal to the frequency of the signal 310 received from the relay device 1b in the first period. Further, the relay device 1 receives a signal 312 of 82 GHz transmitted from the relay device 1b. The relay device 1 converts the signal 312 to the transmission frequency 72 GHz, and transmits the signal to the relay device 1a as a signal 304 of 72 GHz. The frequency 72 GHz of the signal 304 is equal to the frequency of the signal 301 received from the relay device 1a in the first period.

In the third period, the relay device 1 receives a signal 305 of 72 GHz transmitted from the relay device 1a. The relay device 1 converts the signal 305 to the transmission frequency 82 GHz, and transmits the signal to the relay device 1b as a signal 313 of 82 GHz. The frequency 82 GHz of the signal 313 is equal to the frequency of the signal 312 received from the relay device 1b in the second period. Further, the relay device 1 receives a signal 314 of 75 GHz transmitted from the relay device 1b. The relay device 1 converts the signal 314 to the transmission frequency 85 GHz, and transmits the signal to the relay device 1a as a signal 306 of 85 GHz. The frequency 85 GHz of the signal 306 is equal to the frequency of the signal 303 received from the relay device 1a in the second period.

In the fourth period, the relay device 1 receives a signal 307 of 85 GHz transmitted from the relay device 1a. The relay device 1 converts the signal 307 to the transmission frequency 75 GHz, and transmits the signal to the relay device 1b as a signal 315 of 75 GHz. The frequency 75 GHz of the signal 315 is equal to the frequency of the signal 314 received from the relay device 1b in the third period. Further, the relay device 1 receives a signal 316 of 82 GHz transmitted from the relay device 1b. The relay device 1 converts the signal 316 to the transmission frequency 72 GHz, and transmits the signal to the relay device 1a as a signal 308 of 72 GHz. The frequency 72 GHz of the signal 308 is equal to the frequency of the signal 305 received from the relay device 1a in the third period.

When performing the transmission to the relay device 1a, the relay device 1 uses the same frequency as the frequency received from the same relay device 1a before the frequency is switched. Since the frequency is equal, the relay device 1 can estimate the information regarding the channel state used when performing the transmission to the relay device 1a from the signals received from the relay device 1a before the frequency is switched. Therefore, the relay device 1 can perform the equalization processing (here, pre-equalizing) to the signals to be transmitted to the relay device 1a by using the channel state estimated from the signals received from the relay device 1a. Similarly, also for the signals to be transmitted to the relay device 1b by the relay device 1, the equalization processing (here, pre-equalizing) can be performed by using the channel state estimated from the signals received before the frequency changeover. By performing pre-equalizing, distortion of the channel can be equalizeed beforehand so that it can be expected to receive the signals in the state that the distortion of the channel is canceled or reduced on a reception side.

The value of the transmission frequency, the value of the reception frequency and the combination thereof used in the processing according to the first embodiment illustrated in FIG. 3 and FIG. 4 are just an example, and using the combination of the carrier frequencies different from them is not excluded. When the combination of the carrier frequencies is generalized, it can be said that the relay device 1 repeats the changeover of two carrier frequency patterns. First, in a first carrier frequency pattern, a first frequency is set to the reception frequency of the receiver 11, a second frequency is set to the transmission frequency of the transmitter 12, a third frequency is set to the reception frequency of the receiver 15, and a fourth frequency is set to the transmission frequency of the transmitter 16. In the next second carrier frequency pattern, the fourth frequency is set to the reception frequency of the receiver 11, the third frequency is set to the transmission frequency of the transmitter 12, the second frequency is set to the reception frequency of the receiver 15, and the first frequency is set to the transmission frequency of the transmitter 16. When applied to the processing exemplified in the first embodiment, it can be said that the relay device 1 repeats the first carrier frequency pattern and the second carrier frequency pattern.

### First Modification

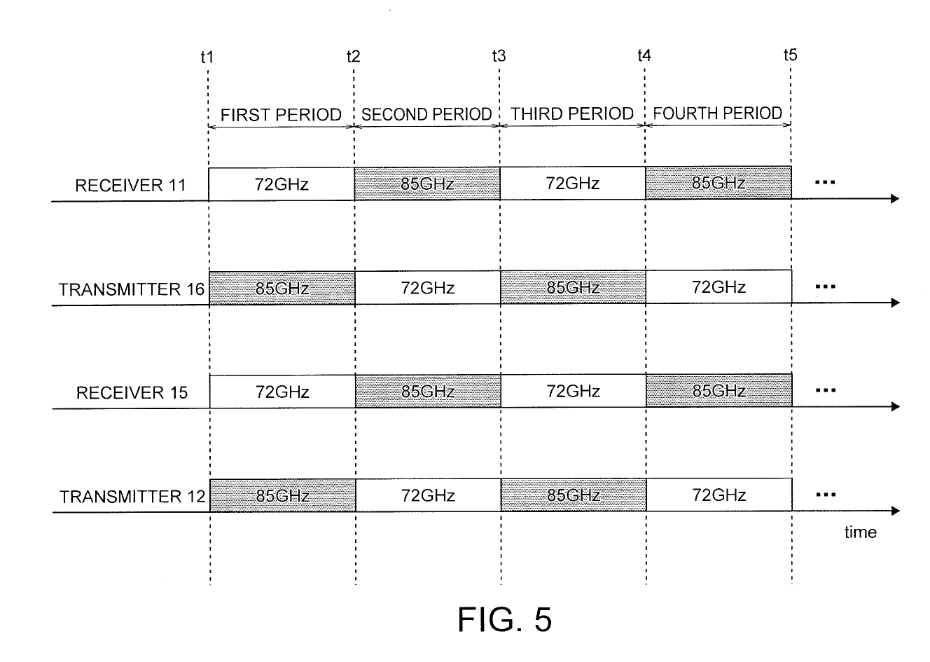

FIG. 5 illustrates another example that the respective parts of the relay device time-sequentially perform the processing of switching the frequency used in the data transmission/reception. While the total of four frequencies are used in transmission/reception processing of the relay device in the processing illustrated in FIG. 3, the total of two frequencies are used in the processing illustrated in FIG. 5.

At the time t1, the controller 18 sets the reception frequency of the receiver 11 to 72 GHz. Thus, the receiver 11 can receive the radio waves at the frequency 72 GHz by the antenna 10. Further, the controller 18 sets the transmission frequency of the transmitter 12 to 85 GHz. Thus, the transmitter 12 can frequency-convert the signals received in the receiver 11 to 85 GHz and transmit the signals from the antenna 13. At the same time t1, the controller 18 sets the reception frequency of the receiver 15 to 72 GHz. Thus, the receiver 15 can receive the radio waves at the frequency 72 GHz by the antenna 14. Further, the controller 18 sets the transmission frequency of the transmitter 16 to 85 GHz. Thus, the transmitter 16 can frequency-convert the signals received in the receiver 15 to 85 GHz and transmit the signals from the antenna 17.

At the time t1, since 85 GHz which is the frequency used in the data transmission is different from 72 GHz which is the frequency used in the data reception, even when the data are transmitted and received at the same time, occurrence of the sneak path interference within the same relay device can be suppressed.

At the time t2, the controller 18 sets the reception frequency of the receiver 11 to 85 GHz. Thus, the receiver 11 can receive the radio waves at the frequency 85 GHz by the antenna 10. Further, the controller 18 sets the transmission frequency of the transmitter 12 to 72 GHz. Thus, the transmitter 12 can frequency-convert the signals received in the receiver 11 to 72 GHz and transmit the signals from the antenna 13. At the same time t2, the controller 18 sets the reception frequency of the receiver 15 to 85 GHz. Thus, the receiver 15 can receive the radio waves at the frequency 85 GHz by the antenna 14. Further, the controller 18 sets the transmission frequency of the transmitter 16 to 72 GHz. Thus, the transmitter 16 can frequency-convert the signals received in the receiver 15 to 72 GHz and transmit the signals from the antenna 17.

The transmission frequency 72 GHz set to the transmitter 12 and the transmitter 16 at the time t2 is the same as the reception frequency 72 GHz set to the receiver 11 and the receiver 15 at the time t1. Since the reception frequency before the carrier frequency changeover is equal to the transmission frequency after the carrier frequency changeover, transmission channel state can be estimated from the information regarding the reception channel state acquired before the carrier frequency changeover timing.

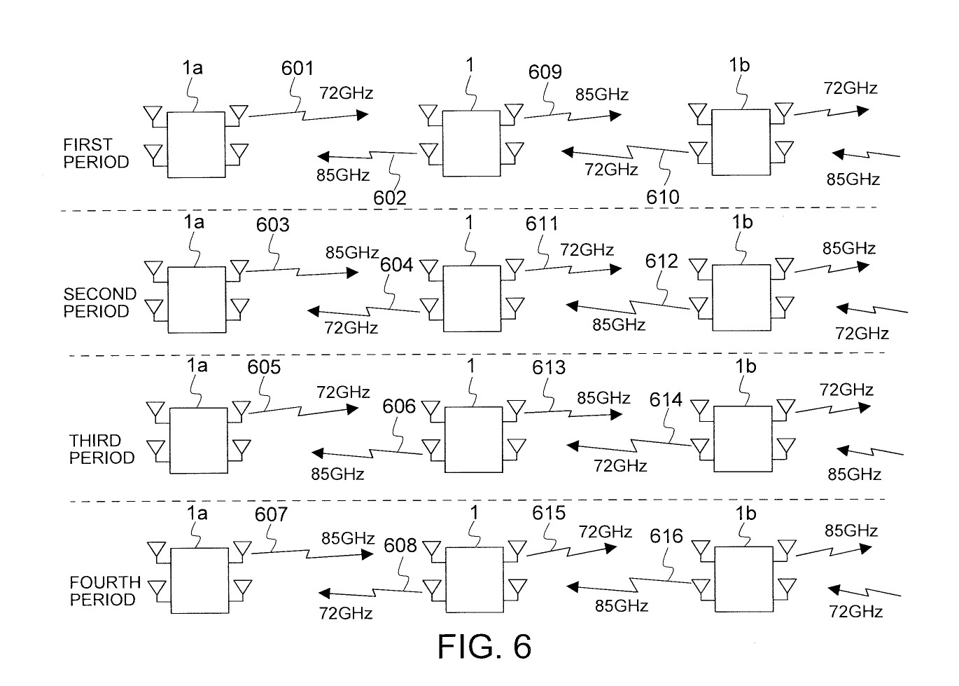

FIG. 6 is a diagram time-sequentially illustrating a relation between the physical arrangement and the carrier frequency of the plurality of wireless relay devices for the first modification of the first embodiment.

In the first period, the relay device 1 receives a signal 601 of 72 GHz transmitted from the relay device 1a. The relay device 1 converts the signal 601 to the transmission frequency 85 GHz, and transmits the signal to the relay device 1b as a signal 609 of 85 GHz. Further, the relay device 1 receives a signal 610 of 72 GHz transmitted from the relay device 1b. The relay device 1 converts the signal 610 to the transmission frequency 85 GHz, and transmits the signal to the relay device 1a as a signal 602 of 85 GHz.

In the second period, the relay device 1 receives a signal 603 of 85 GHz transmitted from the relay device 1a. The relay device 1 converts the signal 603 to the transmission frequency 72 GHz, and transmits the signal to the relay device 1b as a signal 611 of 72 GHz. The frequency 72 GHz of the signal 611 is equal to the frequency of the signal 610 received from the relay device 1b in the first period. Further, the relay device 1 receives a signal 612 of 85 GHz transmitted from the relay device 1b. The relay device 1 converts the signal 612 to the transmission frequency 72 GHz, and transmits the signal to the relay device 1a as a signal 604 of 72 GHz. The frequency 72 GHz of the signal 604 is equal to the frequency of the signal 601 received from the relay device 1a in the first period.

In the third period, the relay device 1 receives a signal 605 of 72 GHz transmitted from the relay device 1a. The relay device 1 converts the signal 605 to the transmission frequency 85 GHz, and transmits the signal to the relay device 1b as a signal 613 of 85 GHz. The frequency 85 GHz of the signal 613 is equal to the frequency of the signal 612 received from the relay device 1b in the second period. Further, the relay device 1 receives a signal 614 of 72 GHz transmitted from the relay device 1b. The relay device 1 converts the signal 614 to the transmission frequency 85 GHz, and transmits the signal to the relay device 1a as a signal 606 of 85 GHz. The frequency 85 GHz of the signal 606 is equal to the frequency of the signal 603 received from the relay device 1a in the second period.

In the fourth period, the relay device 1 receives a signal 607 of 85 GHz transmitted from the relay device 1a. The relay device 1 converts the signal 607 to the transmission frequency 72 GHz, and transmits the signal to the relay device 1b as a signal 615 of 72 GHz. The frequency 72 GHz of the signal 615 is equal to the frequency of the signal 614 received from the relay device 1b in the third period. Further, the relay device 1 receives a signal 616 of 85 GHz transmitted from the relay device 1b. The relay device 1 converts the signal 616 to the transmission frequency 72 GHz, and transmits the signal to the relay device 1a as a signal 608 of 72 GHz. The frequency 72 GHz of the signal 608 is equal to the frequency of the signal 605 received from the relay device 1a in the third period.

Also for the relay device 1 according to the first modification of the first embodiment, when performing the transmission to the relay device 1a, the same frequency as the frequency received from the same relay device 1a before the frequency is switched is used. The relay device 1 can perform pre-equalizing to the signals to be transmitted to the relay device 1a at the same frequency, using the channel state estimated from the signals received from the relay device 1a. Similarly, also for the signals to be transmitted to the relay device 1b by the relay device 1, pre-equalizing can be performed by using the channel state estimated from the signals received before the frequency changeover.

The value of the transmission frequency, the value of the reception frequency and the combination thereof used in the processing according to the first modification of the first embodiment illustrated in FIG. 5 and FIG. 6 are just an example, and using the combination of the carrier frequencies different from them is not excluded. When the combination of the carrier frequencies is generalized, it can be said that the relay device 1 repeats the changeover of two carrier frequency patterns here as well. First, in the first carrier frequency pattern, the first frequency is set to the reception frequency of the receiver 11, the second frequency is set to the transmission frequency of the transmitter 12, the first frequency is set to the reception frequency of the receiver 15, and the second frequency is set to the transmission frequency of the transmitter 16. In the next second carrier frequency pattern, the second frequency is set to the reception frequency of the receiver 11, the first frequency is set to the transmission frequency of the transmitter 12, the second frequency is set to the reception frequency of the receiver 15, and the first frequency is set to the transmission frequency of the transmitter 16. When applied to the exemplified processing, it can be said that the relay device 1 repeats the first carrier frequency pattern and the second carrier frequency pattern.

In the wireless relay network illustrated in FIG. 4 and FIG. 6, the plurality of relay devices are successively arranged. In FIG. 4 and FIG. 6, not only the carrier frequency pattern is switched in the relay device 1 but also the carrier frequency pattern is switched in the relay device 1a and the relay device 1b. At the time, a mode of the frequency pattern changeover between the adjacent relay devices has regularity. That is, in the first period, when it is assumed that the relay device 1 is set to the first carrier frequency pattern, the adjacent relay device 1a and the adjacent relay device 1b are set to the second carrier frequency pattern. In the second period, when it is assumed that the relay device 1 is set to the second carrier frequency pattern, the adjacent relay device 1a and the adjacent relay device 1b are set to the first carrier frequency pattern. In the third period, when it is assumed that the relay device 1 is set to the first carrier frequency pattern, the adjacent relay device 1a and the adjacent relay device 1b are set to the second carrier frequency pattern. In the fourth period, when it is assumed that the relay device 1 is set to the second carrier frequency pattern, the adjacent relay device 1a and the adjacent relay device 1b are set to the first carrier frequency pattern. In the case where another relay device is present on a left side of the relay device 1b, the carrier frequency pattern of another relay device coincides with the relay device 1 in each period.

When the mode of the frequency pattern changeover described above is generalized, in the case where the plurality of relay devices are successively arranged, the relay devices are divided into the ones belonging to a first group and the ones belonging to a second group. Here, the first group and the second group mean sets of the relay devices to which the same carrier frequency pattern is set in the same period. In the case where the plurality of relay devices are successively arranged, the relay devices belonging to the first group and the relay devices belonging to the second group are alternatingly installed.

The two of the processing according to the first embodiment illustrated in FIG. 3 and FIG. 4 and the processing according to the first modification of the first embodiment illustrated in FIG. 5 and FIG. 6 are described as examples so far. Between the carrier frequency patterns used in the two types of the processing, there is a difference in the number of the frequencies being used. It is assumed that the carrier frequency is switched time-sequentially for two or more times, but the timing at which the carrier frequency is switched for two or more times is not limited in particular. When various kinds of the timing of switching the frequency are assumed, further more modifications can be realized. The changeover of the carrier frequency may be performed at every fixed cycle, or may be the one of an event driven type to be executed when some conditions are satisfied. In the case that the changeover of the carrier frequency is cyclic, a length of the cycle does not matter.

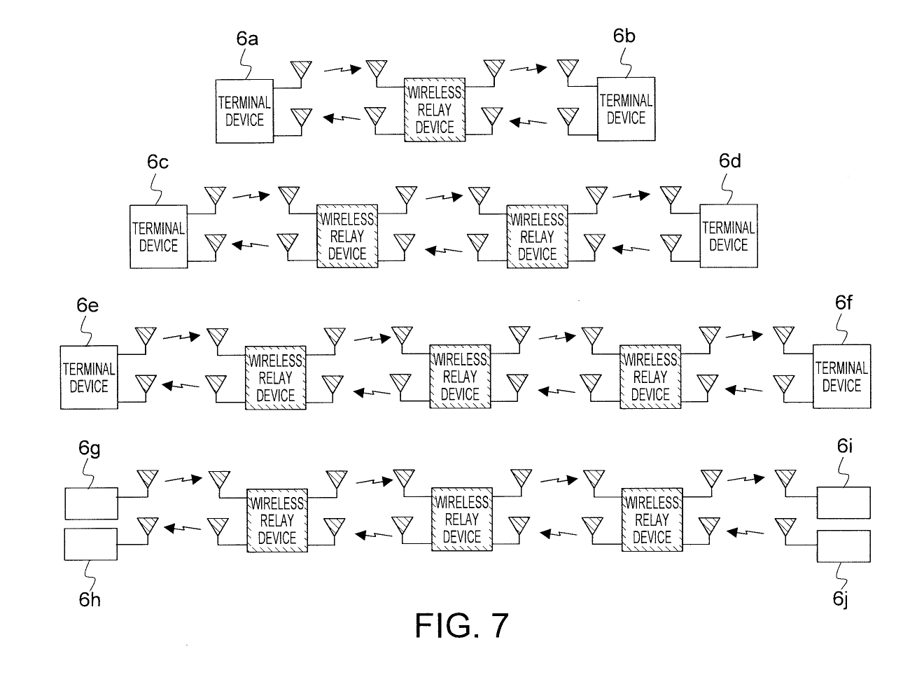

Even though a selection of the carrier frequency changeover timing is not limited in particular as described above, the timing at which the wireless communication device or the relay device that transmits and receives the radio waves to/from the relay device 1 switches the carrier frequency needs to be synchronized with the timing at which the relay device 1 switches the carrier frequency. The synchronization of the carrier frequency changeover timing will be specifically described using FIG. 7.

It is described that the carrier frequency changeover timings of the transmitter and the receiver of the relay device and the wireless communication device configuring the wireless relay network become identical in the description so far, but the frequency changeover timings of the receiver and the transmitter do not need to strictly coincide. For example, in the case where the processing of the transmission or the reception of data is not completed yet for any direction even when a specified carrier frequency changeover timing comes, the frequency changeover of the transmitter or the receiver may be performed after the transmission or the reception of the data being performed at present is completed.

For example, in the case where the data reception in the receiver 11 continues even when the carrier frequency changeover timing comes and the received data needs to be continuously transmitted by the transmitter 12, the frequency changeover timing of the receiver 11 and the transmitter 12 may be after that of the transmitter 16 and the receiver 15.

In addition, even when a command to simultaneously switch the frequency in all of the receiver 11, the transmitter 12, the receiver 15 and the transmitter 16 is issued, the timings of actually switching the frequency in the receiver 11, the transmitter 12, the receiver 15 and the transmitter 16 sometimes vary due to factors on program processing of the controller 18 or the circuit implementation of the local oscillators 20 and 21 and the mixers 11A, 12A, 15A and 16A or the like, but it can be said that even such a device is included in the scope of the embodiment of the present invention as long as the occurrence of the interference is suppressed.

In the wireless relay network in a top stage illustrated in FIG. 7, one relay device is used for a purpose of relaying the communication performed between a terminal device 6a and a terminal device 6b. In the case of using such a configuration, for the transmission antenna of the terminal device 6a, the reception antenna of the terminal device 6a, the transmission antenna of the terminal device 6b, the reception antenna of the terminal device 6b, and the one relay device, the timings of switching the carrier frequency need to be synchronized. The components filled with oblique lines in FIG. 7 correspond to the range where the carrier frequency changeover timings are synchronized. The terminal device 6a and the terminal device 6b also include the configuration equivalent to that excluding a function regarding relay in the configuration in FIG. 1.

In the wireless relay network in a second stage from top in FIG. 7, two relay devices are used for the purpose of relaying the communication performed between a terminal device 6c and a terminal device 6d. In the case of using such a configuration, for the transmission antenna of the terminal device 6c, the reception antenna of the terminal device 6c, the transmission antenna of the terminal device 6d, the reception antenna of the terminal device 6d, and the two relay devices, the timings of switching the carrier frequency need to be synchronized. The components filled with oblique lines in FIG. 7 correspond to the range where the carrier frequency changeover timings are synchronized. The terminal device 6c and the terminal device 6d also include the configuration equivalent to that excluding the function regarding the relay in the configuration in FIG. 1.

In the wireless relay network in a third stage from the top in FIG. 7, three relay devices are used for the purpose of relaying the communication performed between a terminal device 6e and a terminal device 6f. In the case of using such a configuration, for the transmission antenna of the terminal device 6e, the reception antenna of the terminal device 6e, the transmission antenna of the terminal device 6f, the reception antenna of the terminal device 6f, and the three relay devices, the timings of switching the carrier frequency need to be synchronized. The components filled with oblique lines in FIG. 7 correspond to the range where the carrier frequency changeover timings are synchronized. The terminal device 6e and the terminal device 6f also include the configuration equivalent to that excluding the function regarding the relay in the configuration in FIG. 1.

In the wireless relay network in a fourth stage from the top in FIG. 7, three relay devices are used for the purpose of relaying the communication performed between a terminal device 6g and a terminal device 6i and the communication performed between a terminal device 6h and a terminal device 6j. In the case of using such a configuration, for the transmission antenna of the terminal device 6g, the reception antenna of the terminal device 6i, the transmission antenna of the terminal device 6j, the reception antenna of the terminal device 6h, and the three relay devices, the timings of switching the carrier frequency need to be synchronized. The components filled with oblique lines in FIG. 7 correspond to the range where the carrier frequency changeover timings are synchronized. A set of the terminal device 6g and the terminal device 6h and a set of the terminal device 6i and the terminal device 6j also include the configuration equivalent to that excluding the function regarding the relay in the configuration in FIG. 1.

When the relation described above is generalized, in the case where “n” relay devices that perform relay processing of the radio waves are successively installed, it can be said that the range where the frequency changeover timings are synchronized includes, in addition to the “n” relay devices, the antennas of the terminal device or the relay device that transmit or receive the radio waves directly with the antennas positioned at both ends of a series of the “n” relay devices. The synchronization processing of the frequency changeover timing may be autonomously performed by the function of the synchronizers of the “n” relay devices, may be performed by receiving an external command from a management terminal or a management server or the like, or may be performed by the combination thereof, and an mounting method is not limited in particular.

### Second Embodiment

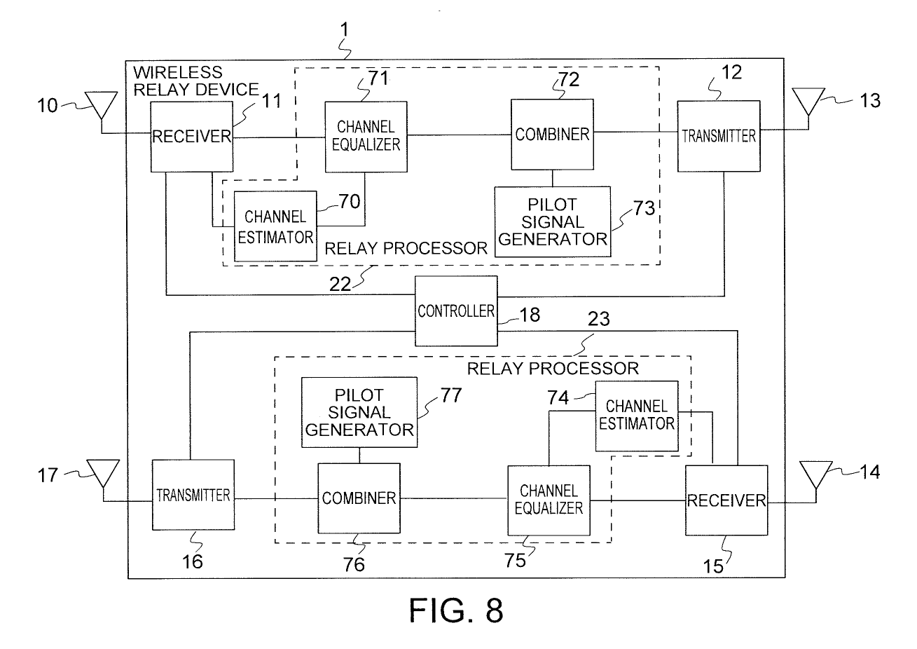

FIG. 8 is a functional block diagram of the relay device as the wireless communication device according to the second embodiment. The relay Processor 22 according to the second embodiment includes a channel estimator 70, a channel equalizer 71, a combiner 72, and a pilot signal generator 73. Similarly, the relay processor 23 includes a channel estimator 74, a channel equalizer 75, a combiner 76, and a pilot signal generator 77. The antenna 10, the receiver 11, the transmitter 12, the antenna 13, the antenna 14, the receiver 15, the transmitter 16, the antenna 17 and the controller 18 of the relay device according to the second embodiment have the functions respectively equivalent to that of the antenna 10, the receiver 11, the transmitter 12, the antenna 13, the antenna 14, the receiver 15, the transmitter 16, the antenna 17 and the controller 18 according to the first embodiment, respectively. Even though not illustrated in FIG. 8, the relay device according to the second embodiment also includes the local oscillator having the function equivalent to that of the local oscillator 20 and the local oscillator 21 of the relay device according to the first embodiment.

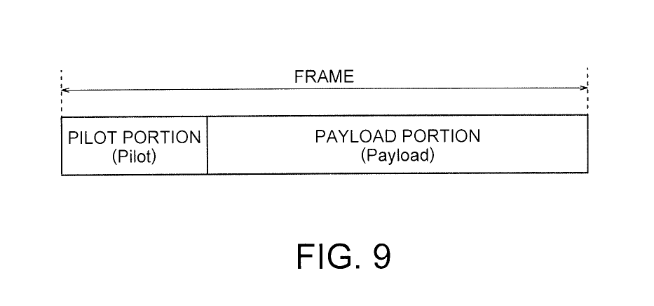

FIG. 9 is a diagram illustrating a format of a frame transmitted by the relay device according to the second embodiment. The frame according to the second embodiment includes a pilot portion including a pilot signal configured from a plurality of pilot symbols, and a payload portion including a data main body.

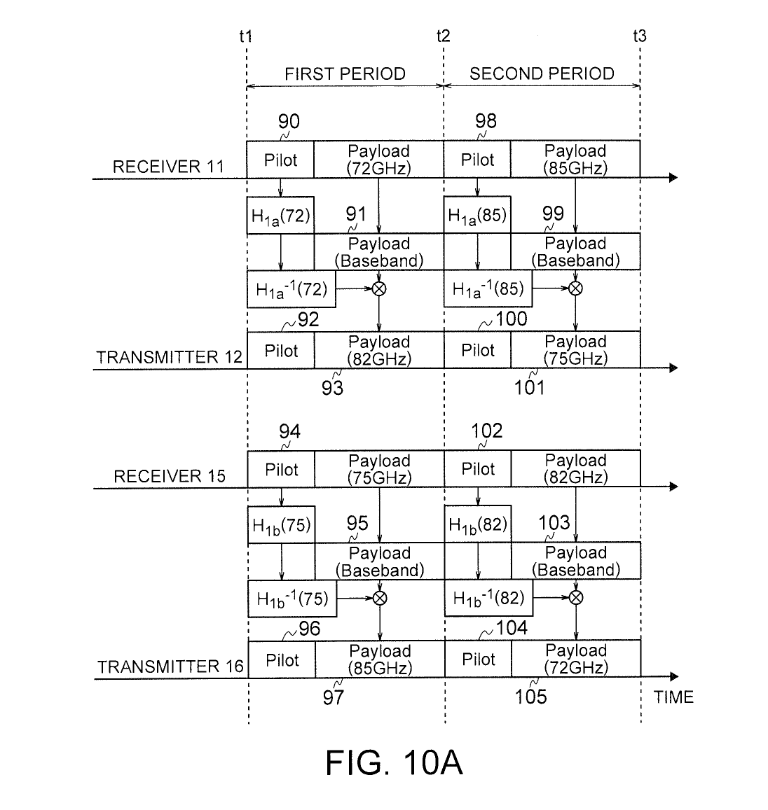

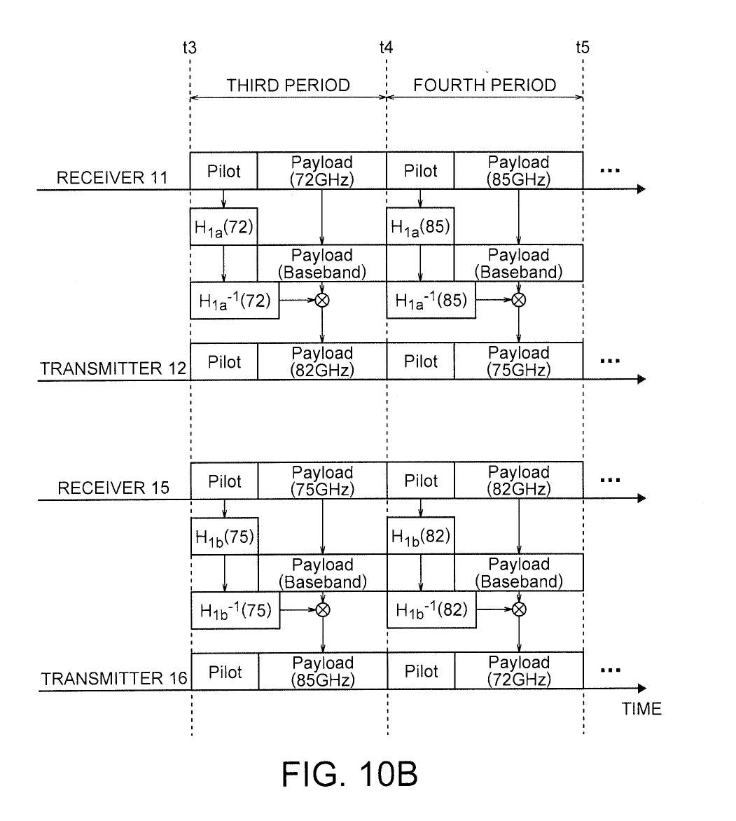

FIG. 10A and FIG. 10B are diagrams illustrating the processing performed to the frame by the relay device according to the second embodiment. The carrier frequency is switched respectively at the time t1, the time t2, the time t3, the time t4, and the time t5. The first period indicates the period between the time t1 and the time t2. The second period indicates the period between the time t2 and the time t3. The third period indicates the period between the time t3 and the time t4. The fourth period indicates the period between the time t4 and the time t5. In FIG. 10A and FIG. 10B, for the respective periods, an outline of the processing performed to the frame received by the relay device 1 is illustrated in a direction from top to bottom. Hereinafter, the processing performed for the frame will be described along FIG. 10A and FIG. 10B.

First, the processing for the first period will be described. At the time t1, the controller 18 sets the reception frequency of the receiver 11 to 72 GHz. The frame transmitted at the transmission frequency 72 GHz from the relay device 1a is received by the antenna 10, and converted to the intermediate frequency used by a baseband signal in the receiver 11. The channel estimator 70 refers to the pilot signal included in a pilot portion 90 of the received frame, and estimates a channel state H₁ₐ(72) between the relay device 1 and the relay device 1a. The channel equalizer 71 performs channel equalization to a payload portion 91 of the frame by using an inverse characteristic H₁ₐ⁻¹(72) of the channel state. The combiner 72 combines a equalizeed payload portion 93 and a new pilot portion 92 generated by the pilot signal generator 73 to configure a new frame. The controller 18 sets the transmission frequency of the transmitter 12 to 82 GHz at the time t1. Therefore, the transmitter 12 converts the baseband signal to the transmission frequency 82 GHz, and then transmits signals including the new frame from the antenna 13 to the relay device 1b.

In the same first period, the processing for the frame received by the receiver 15 will be also described. At the time t1, the controller 18 sets the reception frequency of the receiver 15 to 75 GHz. The frame transmitted at the transmission frequency 75 GHz from the relay device 1b is received by the antenna 14, and converted to the intermediate frequency used by the baseband signal in the receiver 15. The channel estimator 74 refers to the pilot signal included in a pilot portion 94 of the received frame, and estimates a channel state H_{1b}(75) between the relay device 1 and the relay device 1b. The channel equalizer 75 performs the channel equalization to a payload portion 95 of the frame by using an inverse characteristic H_{1b}⁻¹(75) of the channel state. The combiner 76 combines a equalizeed payload portion 97 and a new pilot portion 96 generated by the pilot signal generator 77 to configure a new frame. The controller 18 sets the transmission frequency of the transmitter 16 to 85 GHz at the time t1. Therefore, the transmitter 16 converts the baseband signal to the transmission frequency 85 GHz, and then transmits signals including the new frame from the antenna 17 to the relay device 1a.

Next, the processing in the second period will be described. At the time t2, the controller 18 sets the reception frequency of the receiver 11 to 85 GHz. The frame transmitted at the transmission frequency 85 GHz from the relay device 1a is received by the antenna 10, and converted to the intermediate frequency used by the baseband signal in the receiver 11. The channel estimator 70 refers to the pilot signal included in a pilot portion 98 of the received frame, and estimates a channel state H₁ₐ(85) between the relay device 1 and the relay device 1a. The channel equalizer 71 performs the channel equalization to a payload portion 99 of the frame by using an inverse characteristic H₁ₐ⁻¹(85) of the channel state. The combiner 72 combines a equalizeed payload portion 101 and a new pilot portion 100 generated by the pilot signal generator 73 to configure a new frame. The controller 18 sets the transmission frequency of the transmitter 12 to 75 GHz at the time t2. Therefore, the transmitter 12 converts the baseband signal to the transmission frequency 75 GHz, and then transmits signals including the new frame from the antenna 13 to the relay device 1b.

In the same second period, the processing for the frame received by the receiver 15 will be also described. At the time t2, the controller 18 sets the reception frequency of the receiver 15 to 82 GHz. The frame transmitted at the transmission frequency 82 GHz from the relay device 1b is received by the antenna 14, and converted to the intermediate frequency used by the baseband signal in the receiver 15. The channel estimator 74 refers to the pilot signal included in a pilot portion 102 of the received frame, and estimates a channel state H_{1b}(82) between the relay device 1 and the relay device 1b. The channel equalizer 75 performs the channel equalization to a payload portion 103 of the frame by using an inverse characteristic H_{1b}⁻¹(82) of the channel state. The combiner 76 combines a equalizeed payload portion 105 and a new pilot portion 104 generated by the pilot signal generator 77 to configure a new frame. The controller 18 sets the transmission frequency of the transmitter 16 to 72 GHz at the time t2. Therefore, the transmitter 16 converts the baseband signal to the transmission frequency 72 GHz, and then transmits signals including the new frame from the antenna 17 to the relay device 1a. The processing performed for the frame received by the relay device 1 in the third period and the fourth period is also similar to the processing in the first period and the second period described above.

### First Modification

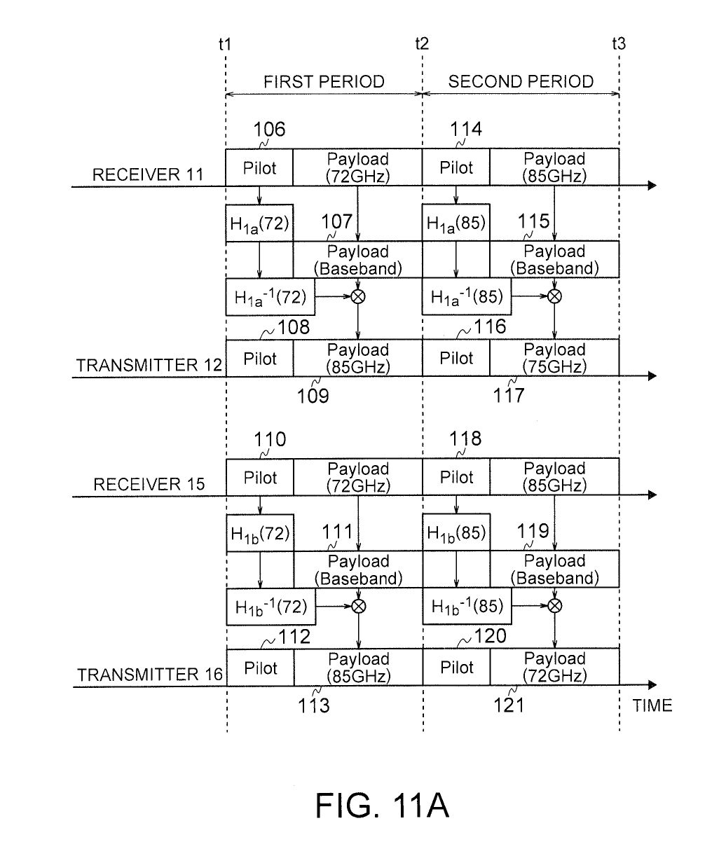

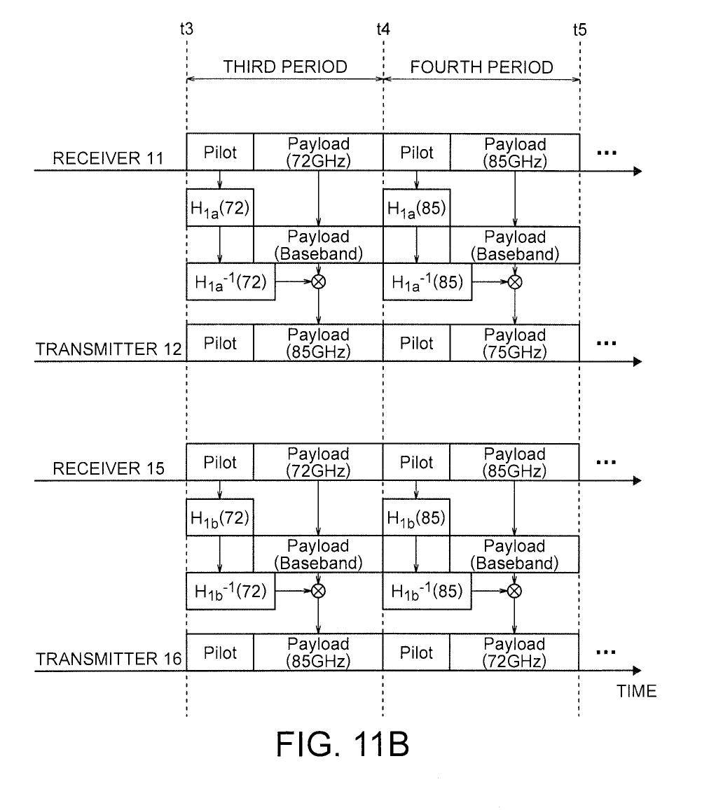

While the total of four frequencies are used in the transmission/reception processing of the relay device in the processing illustrated in FIG. 10A and FIG. 10B, the processing in the case of using the total of two frequencies in the transmission/reception processing is illustrated in FIG. 11A and FIG. 11B as the first modification of the second embodiment. The carrier frequency is switched respectively at the time t1, the time t2, the time t3, the time t4, and the time t5 also in FIG. 11A and FIG. 11B.

First, the processing for the first period will be described. At the time t1, the controller 18 sets the reception frequency of the receiver 11 to 72 GHz. The frame transmitted at the transmission frequency 72 GHz from the relay device 1a is received by the antenna 10, and converted to the intermediate frequency used by the baseband signal in the receiver 11. The channel estimator 70 refers to the pilot signal included in a pilot portion 106 of the received frame, and estimates a channel state H₁ₐ(72) between the relay device 1 and the relay device 1a. The channel equalizer 71 performs the channel equalization to a payload portion 107 of the frame by using the inverse characteristic H₁ₐ⁻¹(72) of the channel state. The combiner 72 combines a equalizeed payload portion 109 and a new pilot portion 108 generated by the pilot signal generator 73 to configure a new frame. The controller 18 sets the transmission frequency of the transmitter 12 to 85 GHz at the time t1. Therefore, the transmitter 12 converts the baseband signal to the transmission frequency 85 GHz, and then transmits signals carrying the new frame from the antenna 13 to the relay device 1b.

In the same first period, the processing for the frame received by the receiver 15 will be also described. At the time t1, the controller 18 sets the reception frequency of the receiver 15 to 72 GHz. The frame transmitted at the transmission frequency 72 GHz from the relay device 1b is received by the antenna 14, and converted to the intermediate frequency used by the baseband signal in the receiver 15. The channel estimator 74 refers to the pilot signal included in a pilot portion 110 of the received frame, and estimates a channel state H_{1b}(72) between the relay device 1 and the relay device 1b. The channel equalizer 75 performs the channel equalization to a payload portion 111 of the frame by using an inverse characteristic H_{1b}⁻¹(72) of the channel state. The combiner 76 combines a equalizeed payload portion 113 and a new pilot portion 112 generated by the pilot signal generator 77 to configure a new frame. The controller 18 sets the transmission frequency of the transmitter 16 to 85 GHz at the time t1. Therefore, the transmitter 16 converts the baseband signal to the transmission frequency 85 GHz, and then transmits signals carrying the new frame from the antenna 17 to the relay device 1a.

Next, the processing in the second period will be described. At the time t2, the controller 18 sets the reception frequency of the receiver 11 to 85 GHz. The frame transmitted at the transmission frequency 85 GHz from the relay device 1a is received by the antenna 10, and converted to the intermediate frequency used by the baseband signal in the receiver 11. The channel estimator 70 refers to the pilot signal included in a pilot portion 114 of the received frame, and estimates the channel state H₁ₐ(85) between the relay device 1 and the relay device 1a. The channel equalizer 71 performs the channel equalization to a payload portion 115 of the frame by using the inverse characteristic H₁ₐ⁻¹(85) of the channel state. The combiner 72 combines a equalizeed payload portion 117 and a new pilot portion 116 generated by the pilot signal generator 73 to configure a new frame. The controller 18 sets the transmission frequency of the transmitter 12 to 72 GHz at the time t2. Therefore, the transmitter 12 converts the baseband signal to the transmission frequency 72 GHz, and then transmits signals including the new frame from the antenna 13 to the relay device 1b.

In the same second period, the processing for the frame received by the receiver 15 will be also described. At the time t2, the controller 18 sets the reception frequency of the receiver 15 to 85 GHz. The frame transmitted at the transmission frequency 85 GHz from the relay device 1b is received by the antenna 14, and converted to the intermediate frequency used by the baseband signal in the receiver 15. The channel estimator 74 refers to the pilot signal included in a pilot portion 118 of the received frame, and estimates a channel state H_{1b}(85) between the relay device 1 and the relay device 1b. The channel equalizer 75 performs the channel equalization to a payload portion 119 of the frame by using an inverse characteristic H_{1b}⁻¹(85) of the channel state. The combiner 76 combines a equalizeed payload portion 121 and a new pilot portion 120 generated by the pilot signal generator 77 to configure a new frame. The controller 18 sets the transmission frequency of the transmitter 16 to 72 GHz at the time t2. Therefore, the transmitter 16 converts the baseband signal to the transmission frequency 72 GHz, and then transmits signals including the new frame from the antenna 17 to the relay device 1a. The processing performed for the frame received by the relay device 1 in the third period and the fourth period is also similar to the processing in the first period and the second period described above.

As described above, by obtaining the inverse characteristic based on the information of the channel state at the time of the reception and equalizing the distortion of the signals for the payload portion, an effect of improving the transmission characteristic (suppressing degradation of transmission signals) can be obtained. For example, for the data carried by the radio waves relayed by the relay device, an SER (Symbol Error Rate) is reduced, and more efficient data transfer is made possible.

### Third Embodiment

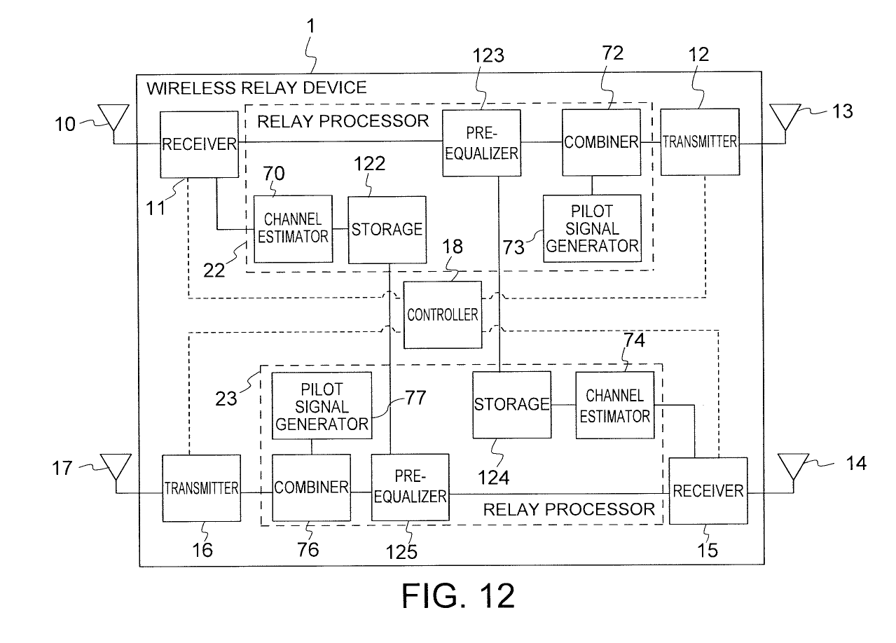

FIG. 12 is a functional block diagram of the relay device as the wireless communication device according to the third embodiment. The relay processor 22 according to the third embodiment includes the channel estimator 70, the combiner 72, the pilot signal generator 73, a storage 122, and a pre-equalizer 123. Similarly, the relay processor 23 includes the channel estimator 74, the combiner 76, the pilot signal generator 77, a storage 124 and a pre-equalizer 125. The antenna 10, the receiver 11, the transmitter 12, the antenna 13, the antenna 14, the receiver 15, the transmitter 16, the antenna 17 and the controller 18 of the relay device according to the third embodiment have the functions respectively equivalent to that of the antenna 10, the receiver 11, the transmitter 12, the antenna 13, the antenna 14, the receiver 15, the transmitter 16, the antenna 17 and the controller 18 according to the first embodiment, respectively. In addition, the relay device according to the third embodiment also includes the local oscillator having the function equivalent to that of the local oscillator 20 and the local oscillator 21 of the relay device according to the first embodiment.

The storages 122 and 124 are configured from any one of a nonvolatile storage device such as a NAND flash memory, an NOR flash memory, an MRAM, a ReRAM, a hard disk or an optical disk or a storage device such as a DRAM or the combination thereof.

The third embodiment is an example of the relay device which estimates the transmission channel state by the information regarding the reception channel state acquired before the carrier frequency changeover timing, and performs pre-equalizing utilizing the estimated transmission channel state.

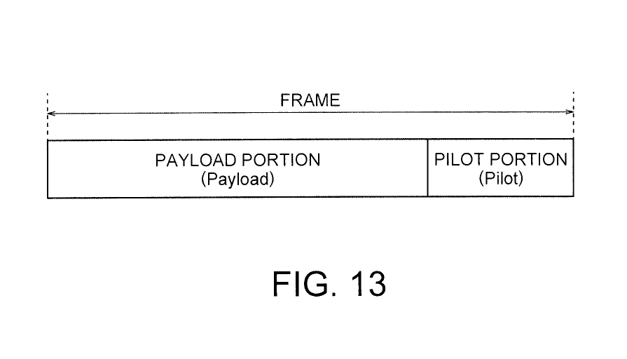

FIG. 13 is a diagram illustrating a format of the frame transmitted by the relay device according to the third embodiment. The frame according to the third embodiment includes the payload portion including the data main body and the pilot portion including the pilot symbol.

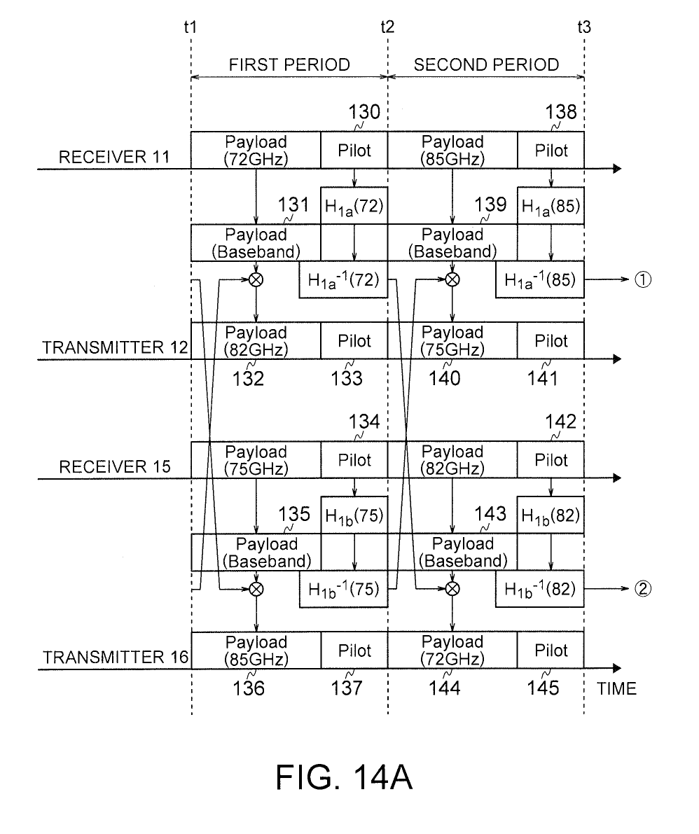

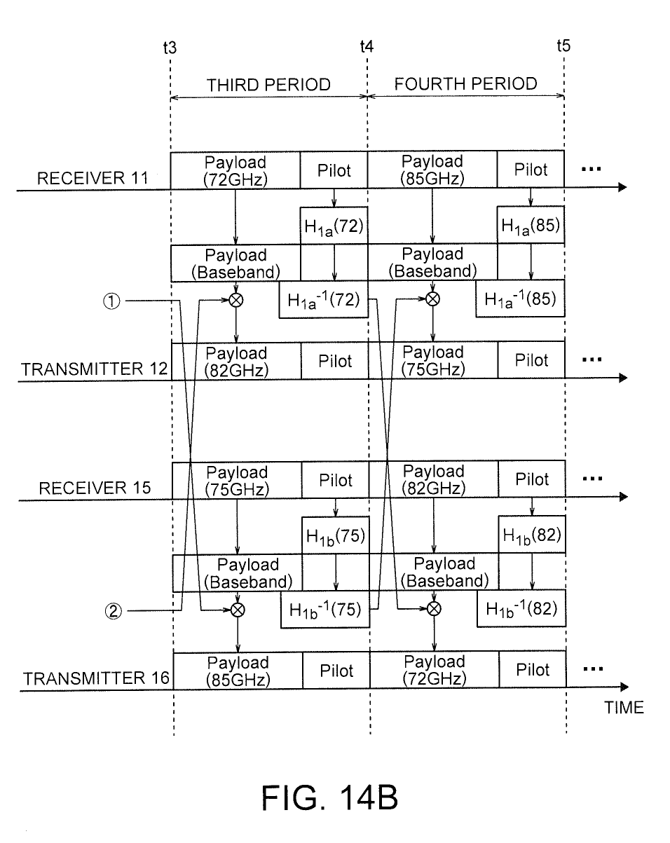

FIG. 14A and FIG. 14B are diagrams illustrating the processing performed to the frame by the relay device according to the third embodiment. The carrier frequency is switched respectively at the time t1, the time t2, the time t3, the time t4, and the time t5. The first period indicates the period between the time t1 and the time t2. The second period indicates the period between the time t2 and the time t3. The third period indicates the period between the time t3 and the time t4. The fourth period indicates the period between the time t4 and the time t5. In FIG. 14A and FIG. 14B, for the respective periods, an outline of the processing performed to the frame received by the relay device 1 is illustrated in the direction from top to bottom. Hereinafter, the processing performed for the frame will be described along FIG. 14A and FIG. 14B.

First, the processing for the first period will be described. At the time t1, the controller 18 sets the reception frequency of the receiver 11 to 72 GHz. The frame transmitted at the transmission frequency 72 GHz from the relay device 1a is received by the antenna 10, and converted to the intermediate frequency used by the baseband signal in the receiver 11. The channel estimator 70 refers to the pilot signal included in a pilot portion 130 of the received frame, and estimates a channel state H₁ₐ(72) between the relay device 1 and the relay device 1a. The channel estimator 70 further obtains the inverse characteristic H₁ₐ⁻¹(72) of the channel state, and preserves the inverse characteristic H₁ₐ⁻¹(72) of the channel state in the storage 122. The pre-equalizer 123 performs pre-equalizing (pre-equalization) to a payload portion 131 of the frame by using the inverse characteristic H_{1b}⁻¹(82) of the channel state with the relay device 1b in the period before the time t1, which is preserved in the storage 124. The pre-equalizing is performed before the transmission to the relay device 1b. The combiner 72 combines a payload portion 132 pre-equalized by the pre-equalizer 123 and a new pilot portion 133 generated by the pilot signal generator 73 to configure a new frame. The controller 18 sets the transmission frequency of the transmitter 12 to 82 GHz at the time t1. Therefore, the transmitter 12 converts the baseband signal to the transmission frequency 82 GHz, and then transmits signals carrying the new frame from the antenna 13 to the relay device 1b.

In the same first period, the processing for the frame received by the receiver 15 will be also described. At the time t1, the controller 18 sets the reception frequency of the receiver 15 to 75 GHz. The frame transmitted at the transmission frequency 75 GHz from the relay device 1b is received by the antenna 14, and converted to the intermediate frequency used by the baseband signal in the receiver 15. The channel estimator 74 refers to the pilot signal included in a pilot portion 134 of the received frame, and estimates the channel state H_{1b}(75) between the relay device 1 and the relay device 1b. The channel estimator 74 further obtains the inverse characteristic H_{1b}⁻¹(75) of the channel state, and preserves the inverse characteristic H_{1b}⁻¹(75) of the channel state in the storage 124. The pre-equalizer 125 performs the pre-equalizing (pre-equalization) to a payload portion 135 of the frame by using the inverse characteristic H₁ₐ⁻¹(85) of the channel state with the relay device 1a in the period before the time t1, which is preserved in the storage 122. The pre-equalizing is performed before the transmission to the relay device 1a. The combiner 76 combines a payload portion 136 pre-equalized by the pre-equalizer 125 and a new pilot portion 137 generated by the pilot signal generator 77 to configure a new frame. The controller 18 sets the transmission frequency of the transmitter 16 to 85 GHz at the time t1. Therefore, the transmitter 16 converts the baseband signal to the transmission frequency 85 GHz, and then transmits signals carrying the new frame from the antenna 17 to the relay device 1a.

Next, the processing in the second period will be described. At the time t2, the controller 18 sets the reception frequency of the receiver 11 to 85 GHz. The frame transmitted at the transmission frequency 85 GHz from the relay device 1a is received by the antenna 10, and converted to the intermediate frequency used by the baseband signal in the receiver 11. The channel estimator 70 refers to the pilot signal included in a pilot portion 138 of the received frame, and estimates the channel state H₁ₐ(85) between the relay device 1 and the relay device 1a. The channel estimator 70 further obtains the inverse characteristic H₁ₐ⁻¹(85) of the channel state, and preserves the inverse characteristic H₁ₐ⁻¹(85) of the channel state in the storage 122. The pre-equalizer 123 performs the pre-equalizing (pre-equalization) to a payload portion 139 of the frame by using the inverse characteristic H_{1b}⁻¹(75) of the channel state with the relay device 1b in the first period before the time t2, which is preserved in the storage 124. The pre-equalizing is performed before the transmission to the relay device 1b. The combiner 72 combines a payload portion 140 pre-equalized by the pre-equalizer 123 and a new pilot portion 141 generated by the pilot signal generator 73 to configure a new frame. The controller 18 sets the transmission frequency of the transmitter 12 to 75 GHz at the time t2. Therefore, the transmitter 12 converts the baseband signal to the transmission frequency 75 GHz, and then transmits signals carrying the new frame from the antenna 13 to the relay device 1b.

In the same second period, the processing for the frame received by the receiver 15 will be also described. At the time t2, the controller 18 sets the reception frequency of the receiver 15 to 82 GHz. The frame transmitted at the transmission frequency 82 GHz from the relay device 1b is received by the antenna 14, and converted to the intermediate frequency used by the baseband signal in the receiver 15. The channel estimator 74 refers to the pilot signal included in a pilot portion 142 of the received frame, and estimates the channel state H_{1b}(82) between the relay device 1 and the relay device 1b. The channel estimator 74 further obtains the inverse characteristic H_{1b}⁻¹(82) of the channel state, and preserves the inverse characteristic H_{1b}⁻¹(82) of the channel state in the storage 124. The pre-equalizer 125 performs the pre-equalizing (pre-equalization) to a payload portion 143 of the frame by using the inverse characteristic H₁ₐ⁻¹(72) of the channel state with the relay device 1a in the first period before the time t2, which is preserved in the storage 122. The pre-equalizing is performed before the transmission to the relay device 1a. The combiner 76 combines a payload portion 144 pre-equalized by the pre-equalizer 125 and a new pilot portion 145 generated by the pilot signal generator 77 to configure a new frame. The controller 18 sets the transmission frequency of the transmitter 16 to 72 GHz at the time t2. Therefore, the transmitter 16 converts the baseband signal to the transmission frequency 72 GHz, and then transmits signals carrying the new frame from the antenna 17 to the relay device 1a. The processing performed for the frame received by the relay device 1 in and after the third period and the fourth period is also similar to the processing in the second period described above.

### First Modification

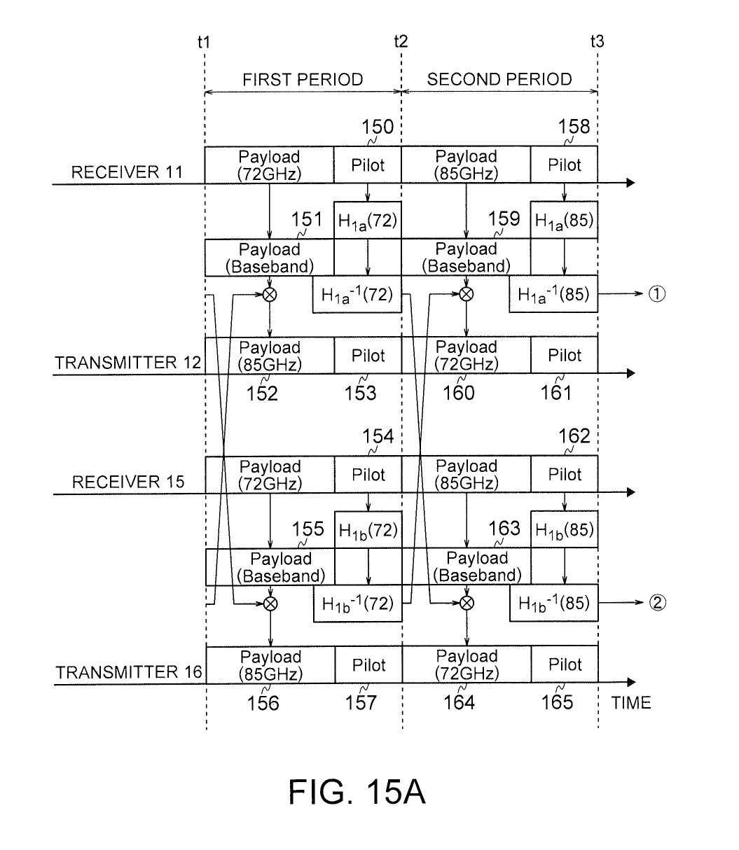

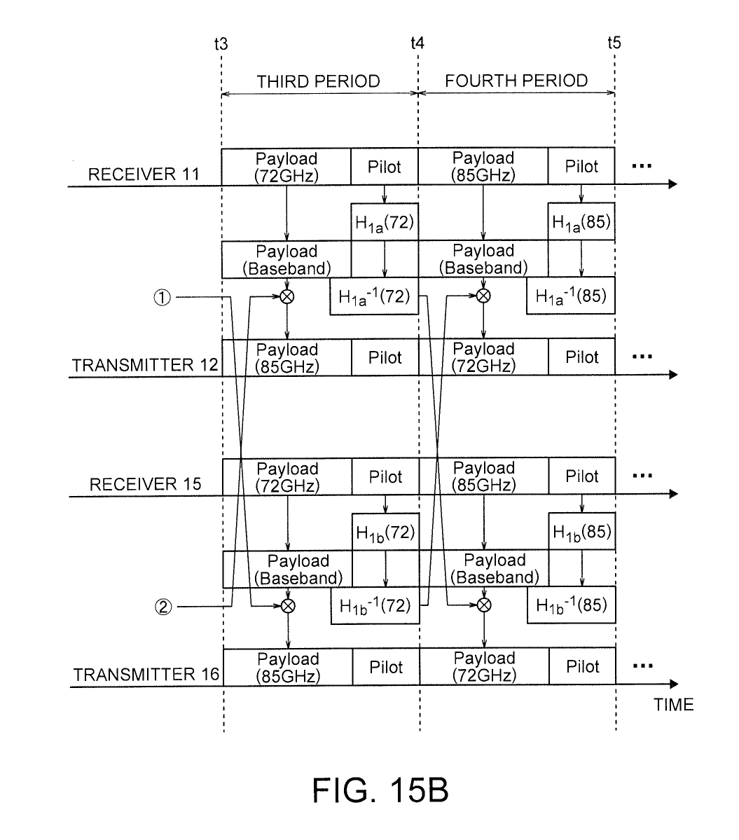

While the total of four frequencies are used in the transmission/reception processing of the relay device in the processing illustrated in FIG. 14A and FIG. 14B, the processing in the case of using the total of two frequencies in the transmission/reception processing is illustrated in FIG. 15A and FIG. 15B, as the first modification of the third embodiment.

First, the processing for the first period will be described. At the time t1, the controller 18 sets the reception frequency of the receiver 11 to 72 GHz. The frame transmitted at the transmission frequency 72 GHz from the relay device 1a is received by the antenna 10, and converted to the intermediate frequency used by the baseband signal in the receiver 11. The channel estimator 70 refers to the pilot signal included in a pilot portion 150 of the received frame, and estimates a channel state H₁ₐ(72) between the relay device 1 and the relay device 1a. The channel estimator 70 further obtains the inverse characteristic H₁ₐ⁻¹(72) of the channel state, and preserves the inverse characteristic H₁ₐ⁻¹(72) of the channel state in the storage 122. The pre-equalizer 123 performs the pre-equalizing (pre-equalization) to a payload portion 151 of the frame by using the inverse characteristic H_{1b}⁻¹(85) of the channel state with the relay device 1b in the period before the time t1, which is preserved in the storage 124. The pre-equalizing is performed before the transmission to the relay device 1b. The combiner 72 combines a payload portion 152 pre-equalized by the pre-equalizer 123 and a new pilot portion 153 generated by the pilot signal generator 73 to configure a new frame. The controller 18 sets the transmission frequency of the transmitter 12 to 85 GHz at the time t1. Therefore, the transmitter 12 converts the baseband signal to the transmission frequency 85 GHz, and then transmits signals carrying the new frame from the antenna 13 to the relay device 1b.

In the same first period, the processing for the frame received by the receiver 15 will be also described. At the time t1, the controller 18 sets the reception frequency of the receiver 15 to 72 GHz. The frame transmitted at the transmission frequency 72 GHz from the relay device 1b is received by the antenna 14, and converted to the intermediate frequency used by the baseband signal in the receiver 15. The channel estimator 74 refers to the pilot signal included in a pilot portion 154 of the received frame, and estimates the channel state H_{1b}(72) between the relay device 1 and the relay device 1b. The channel estimator 74 further obtains the inverse characteristic H_{1b}⁻¹(72) of the channel state, and preserves the inverse characteristic H_{1b}⁻¹(72) of the channel state in the storage 124. The pre-equalizer 125 performs the pre-equalizing (pre-equalization) to a payload portion 155 of the frame by using the inverse characteristic H₁ₐ⁻¹(85) of the channel state with the relay device 1a in the period before the time t1, which is preserved in the storage 122. The pre-equalizing is performed before the transmission to the relay device 1a. The combiner 76 combines a payload portion 156 pre-equalized by the pre-equalizer 125 and a new pilot portion 157 generated by the pilot signal generator 77 to configure a new frame. The controller 18 sets the transmission frequency of the transmitter 16 to 85 GHz at the time t1. Therefore, the transmitter 16 converts the baseband signal to the transmission frequency 85 GHz, and then transmits signals carrying the new frame from the antenna 17 to the relay device 1a.

Next, the processing in the second period will be described. At the time t2, the controller 18 sets the reception frequency of the receiver 11 to 85 GHz. The frame transmitted at the transmission frequency 85 GHz from the relay device 1a is received by the antenna 10, and converted to the intermediate frequency used by the baseband signal in the receiver 11. The channel estimator 70 refers to the pilot signal included in a pilot portion 158 of the received frame, and estimates the channel state H₁ₐ(85) between the relay device 1 and the relay device 1a. The channel estimator 70 further obtains the inverse characteristic H₁ₐ⁻¹(85) of the channel state, and preserves the inverse characteristic H₁ₐ⁻¹(85) of the channel state in the storage 122. The pre-equalizer 123 performs the pre-equalizing (pre-equalization) to a payload portion 159 of the frame by using the inverse characteristic H_{1b}⁻¹(72) of the channel state with the relay device 1b in the first period before the time t2, which is preserved in the storage 124. The pre-equalizing is performed before the transmission to the relay device 1b. The combiner 72 combines a payload portion 160 pre-equalized by the pre-equalizer 123 and a new pilot portion 161 generated by the pilot signal generator 73 to configure a new frame. The controller 18 sets the transmission frequency of the transmitter 12 to 72 GHz at the time t2. Therefore, the transmitter 12 converts the baseband signal to the transmission frequency 72 GHz, and then transmits signals carrying the new frame from the antenna 13 to the relay device 1b.

In the same second period, the processing for the frame received by the receiver 15 will be also described. At the time t2, the controller 18 sets the reception frequency of the receiver 15 to 85 GHz. The frame transmitted at the transmission frequency 85 GHz from the relay device 1b is received by the antenna 14, and converted to the intermediate frequency used by the baseband signal in the receiver 15. The channel estimator 74 refers to the pilot signal included in a pilot portion 162 of the received frame, and estimates the channel state H_{1b}(85) between the relay device 1 and the relay device 1b. The channel estimator 70 further obtains the inverse characteristic H_{1b}⁻¹(85) of the channel state, and preserves the inverse characteristic H_{1b}⁻¹(85) of the channel state in the storage 124. The pre-equalizer 125 performs the pre-equalizing (pre-equalization) to a payload portion 163 of the frame by using the inverse characteristic H₁ₐ⁻¹(72) of the channel state with the relay device 1a in the first period before the time t2, which is preserved in the storage 122. The pre-equalizing is performed before the transmission to the relay device 1a. The combiner 76 combines a payload portion 164 pre-equalized by the pre-equalizer 125 and a new pilot portion 165 generated by the pilot signal generator 77 to configure a new frame. The controller 18 sets the transmission frequency of the transmitter 16 to 72 GHz at the time t2. Therefore, the transmitter 16 converts the baseband signal to the transmission frequency 72 GHz, and then transmits signals carrying the new frame from the antenna 17 to the relay device 1a. The processing performed for the frame received by the relay device 1 in and after the third period and the fourth period is also similar to the processing in the second period described above.

As described above, by using the inverse characteristic of the channel state obtained from the channel state obtained when the reception is previously performed from the same wireless communication device, and performing the pre-equalizing before the transmission for the payload portion received this time, the high transmission characteristic can be obtained. For example, an effect that a channel capacity increases can be obtained. Thus, for the data carried by the radio waves relayed by the relay device, the efficient data transfer can be performed.

### Fourth Embodiment

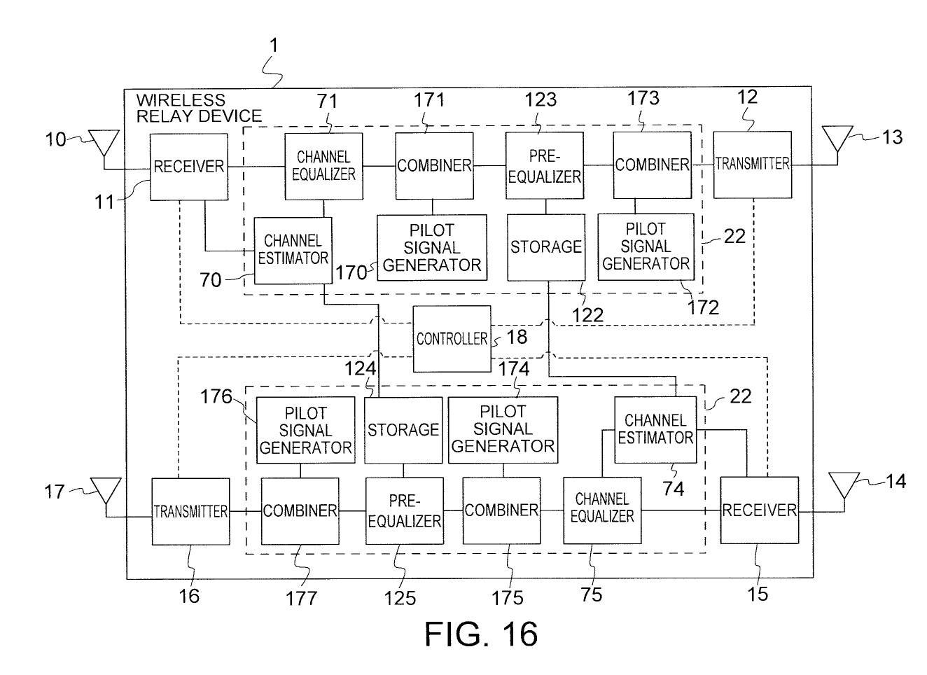

FIG. 16 is a functional block diagram of the relay device as the wireless communication device according to the fourth embodiment. The relay processor 22 according to the fourth embodiment includes the channel estimator 70, the channel equalizer 71, the storage 122, the pre-equalizer 123, a pilot signal generator 170, a combiner 171, a pilot signal generator 172, and a combiner 173. Similarly, the relay processor 23 includes the channel estimator 74, the channel equalizer 75, the storage 124, the pre-equalizer 125, a pilot signal generator 174, a combiner 175, a pilot signal generator 176, and a combiner 177. The antenna 10, the receiver 11, the transmitter 12, the antenna 13, the antenna 14, the receiver 15, the transmitter 16, the antenna 17 and the controller 18 of the relay device according to the fourth embodiment have the configuration and the functions respectively equivalent to that of the antenna 10, the receiver 11, the transmitter 12, the antenna 13, the antenna 14, the receiver 15, the transmitter 16, the antenna 17 and the controller 18 according to the first embodiment, respectively. In addition, the relay device according to the fourth embodiment also includes the local oscillator having the function equivalent to that of the local oscillator 20 and the local oscillator 21 of the relay device according to the first embodiment.

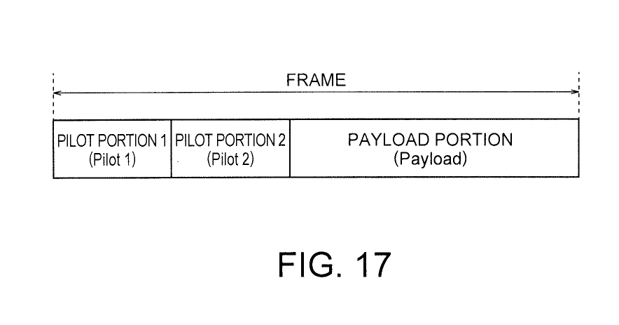

FIG. 17 is a diagram illustrating a format of the frame transmitted by the relay device according to the fourth embodiment. The frame according to the fourth embodiment includes the two pilot portions and the payload portion including the data main body. The two pilot portions are a pilot portion 1 including a first pilot signal and a pilot portion 2 including a second pilot signal, respectively. The case where the pilot portion 1 and the payload portion are pre-equalized and the pilot portion 2 is not pre-equalized is assumed. Note that the configuration may be such that the pilot portion 2 and the payload portion are pre-equalized and the pilot portion 1 is not pre-equalized.

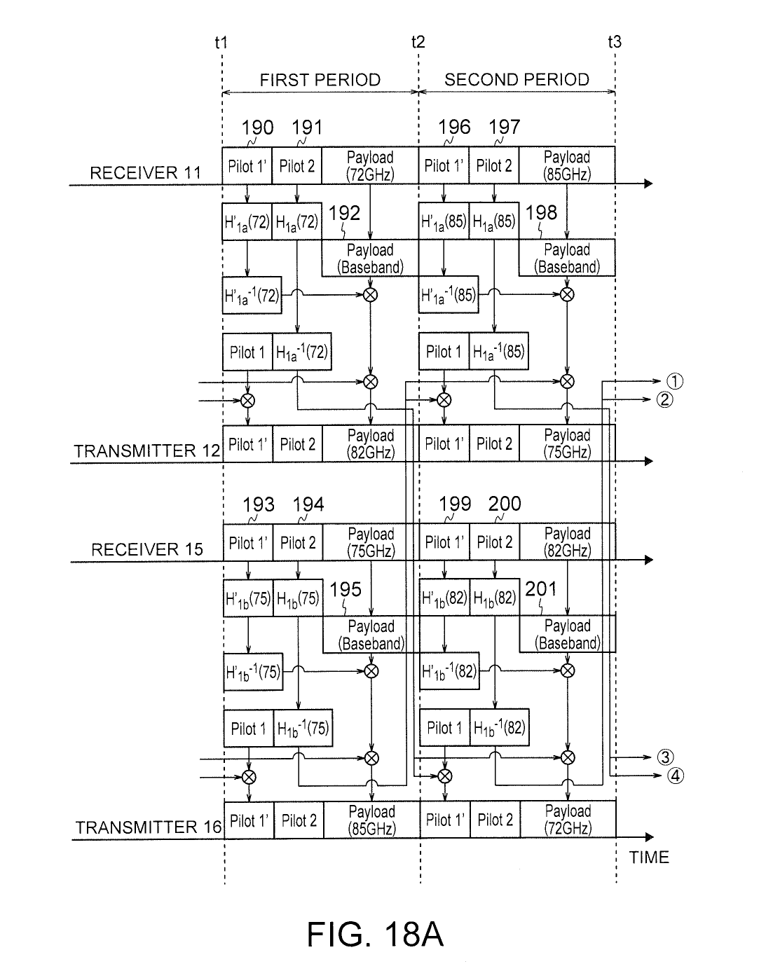

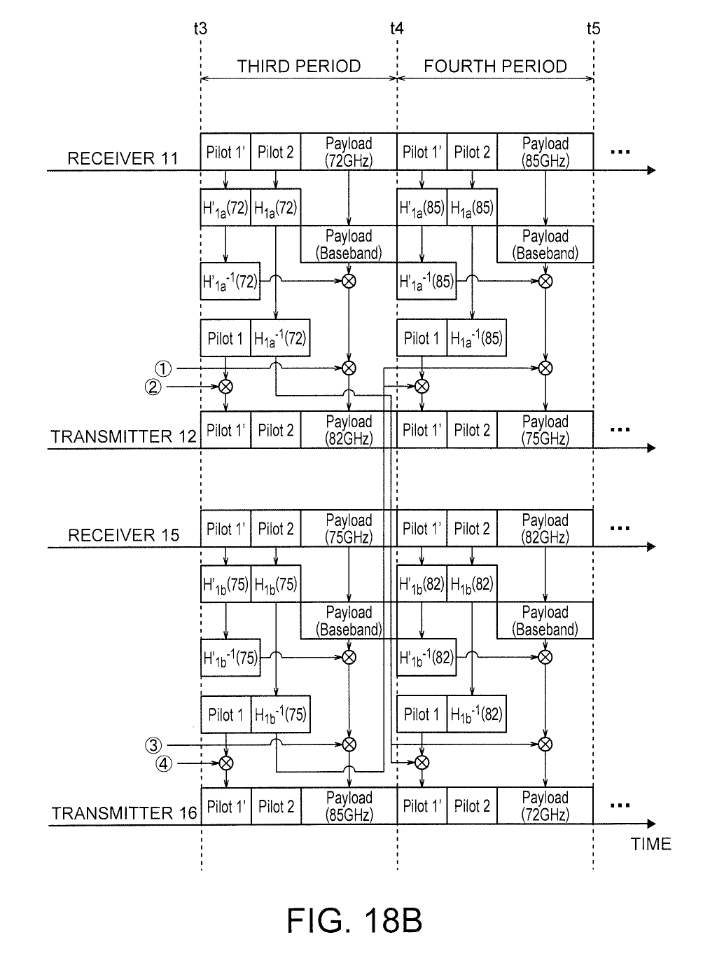

FIG. 18A and FIG. 18B are diagrams illustrating the processing performed to the frame by the relay device according to the fourth embodiment. The carrier frequency is switched respectively at the time t1, the time t2, the time t3, the time t4, and the time t5. The first period indicates the period between the time t1 and the time t2. The second period indicates the period between the time t2 and the time t3. The third period indicates the period between the time t3 and the time t4. The fourth period indicates the period between the time t4 and the time t5. In FIG. 18A and FIG. 18B, for the respective periods, an outline of the processing performed to the frame received by the relay device 1 is illustrated in the direction from top to bottom. Hereinafter, the processing performed for the frame will be described along FIG. 18A and FIG. 18B. Note that, in the figures, the pre-equalized pilot portion 1 is described as “Pilot1” and the pilot portion 1 before being pre-equalized is described as “Pilot1”. First, the processing for the first period will be described.

At the time t1, the controller 18 sets the reception frequency of the receiver 11 to 72 GHz. The frame transmitted at the transmission frequency 72 GHz from the relay device 1a is received by the antenna 10, and converted to the intermediate frequency used by the baseband signal in the receiver 11. The channel estimator 70 refers to the first pilot signal included in the pilot portion 1 (190) of the received frame, and obtains a channel state H′₁ₐ(72). Since the first pilot signal is pre-equalized, influence of channel variation from the channel state information used during the pre-equalizing is included in the H′₁ₐ(72). The channel estimator 70 further refers to the second pilot signal included in the pilot portion 2 (191), and estimates the channel state H₁ₐ(72) between the relay device 1 and the relay device 1a. Since the second pilot signal is not pre-equalized, the channel state H₁ₐ(72) indicates the channel state when the frame is received this time. In addition, the channel estimator 70 obtains the inverse characteristic H₁ₐ⁻¹(72) of the channel state, and preserves the inverse characteristic H₁ₐ⁻¹(72) of the channel state in the storage 124. The channel equalizer 71 obtains H′₁ₐ⁻¹(72) which is the inverse characteristic of the above-described H′₁ₐ(72), and performs the equalization to a payload portion 192 using the H′₁ₐ⁻¹(72). The combiner 171 combines a new pilot portion 1 generated by the pilot signal generator 170 and the channel-equalizeed payload portion. The pre-equalizer 123 performs the pre-equalizing to the channel-equalizeed payload portion and the new pilot portion 1, using the inverse characteristic H_{1b}⁻¹(82) of the channel state with the relay device 1b in the period before the time t1, which is preserved in the storage 122. The pre-equalizing is performed before the transmission to the relay device 1b. The combiner 173 configures a new frame by inserting the pilot portion 2 generated by the pilot signal generator 172 between the pre-equalized pilot portion 1 and the pre-equalized payload portion. Note that the inserted pilot portion 2 is not pre-equalized. The controller 18 sets the transmission frequency of the transmitter 12 to 82 GHz at the time t1. Therefore, the transmitter 12 converts the baseband signal to the transmission frequency 82 GHz, and then transmits signals carrying the new frame from the antenna 13 to the relay device 1b.

In the same first period, the processing for the frame received by the receiver 15 will be also described. At the time t1, the controller 18 sets the reception frequency of the receiver 15 to 75 GHz. The frame transmitted at the transmission frequency 75 GHz from the relay device 1b is received by the antenna 14, and converted to the intermediate frequency used by the baseband signal in the receiver 15. The channel estimator 74 refers to the first pilot signal included in the pilot portion 1 (193) of the received frame, and obtains a channel state H′_{1b}(75). The channel estimator 74 further refers to the second pilot signal included in the pilot portion 2 (194), and estimates the channel state H_{1b}(75). In addition, the channel estimator 74 obtains the inverse characteristic H_{1b}⁻¹(75) of the channel state, and preserves the inverse characteristic H_{1b}⁻¹(75) of the channel state in the storage 122. The channel equalizer 71 obtains H′_{1b}⁻¹(75) which is the inverse characteristic of the above-described H′_{1b}(75), and performs the equalization to a payload portion 195 using the H′_{1b}⁻¹(75). The combiner 175 combines a new pilot portion 1 generated by the pilot signal generator 174 and the channel-equalizeed payload portion. The pre-equalizer 125 performs the pre-equalizing to the channel-equalizeed payload portion and the new pilot portion 1, using the inverse characteristic H₁ₐ⁻¹(85) of the channel state with the relay device 1a in the period before the time t1, which is preserved in the storage 124. The pre-equalizing is performed before the transmission to the relay device 1b. The combiner 177 configures a new frame by inserting the pilot portion 2 generated by the pilot signal generator 176 between the pre-equalized pilot portion 1 and the pre-equalized payload portion. The controller 18 sets the transmission frequency of the transmitter 16 to 85 GHz at the time t1. Therefore, the transmitter 16 converts the baseband signal to the transmission frequency 85 GHz, and then transmits signals carrying the new frame from the antenna 17 to the relay device 1a.

Next, the processing in the second period will be described. At the time t2, the controller 18 sets the reception frequency of the receiver 11 to 85 GHz. The frame transmitted at the transmission frequency 85 GHz from the relay device 1a is received by the antenna 10, and converted to the intermediate frequency used by the baseband signal in the receiver 11. The channel estimator 70 refers to the first pilot signal included in the pilot portion 1 (196) of the received frame, and obtains a channel state H′₁ₐ(85). The channel estimator 70 further refers to the second pilot signal included in the pilot portion 2 (197), and estimates the channel state H₁ₐ(85) between the relay device 1 and the relay device 1a. In addition, the channel estimator 70 obtains the inverse characteristic H₁ₐ⁻¹(85) of the channel state, and preserves the inverse characteristic H₁ₐ⁻¹(85) of the channel state in the storage 124. The channel equalizer 71 obtains H′₁ₐ⁻¹(85) which is the inverse characteristic of the above-described H′₁ₐ(85), and performs the equalization to a payload portion 198 using the H′₁ₐ⁻¹(85). The combiner 171 combines the new pilot portion 1 generated by the pilot signal generator 170 and the channel-equalizeed payload portion. The pre-equalizer 123 performs the pre-equalizing to the channel-equalizeed payload portion and the new pilot portion 1, using the inverse characteristic H_{1b}⁻¹(75) of the channel state with the relay device 1b in the first period before the time t2, which is preserved in the storage 122. The pre-equalizing is performed before the transmission to the relay device 1b. The combiner 173 configures a new frame by inserting the pilot portion 2 generated by the pilot signal generator 172 between the pre-equalized pilot portion 1 and the pre-equalized payload portion. The controller 18 sets the transmission frequency of the transmitter 12 to 75 GHz at the time t2. Therefore, the transmitter 12 converts the baseband signal to the transmission frequency 75 GHz, and then transmits signals carrying the new frame from the antenna 13 to the relay device 1b.

In the same second period, the processing for the frame received by the receiver 15 will be also described. At the time t2, the controller 18 sets the reception frequency of the receiver 15 to 82 GHz. The frame transmitted at the transmission frequency 82 GHz from the relay device 1b is received by the antenna 14, and converted to the intermediate frequency used by the baseband signal in the receiver 15. The channel estimator 74 refers to the first pilot signal included in the pilot portion 1 (199) of the received frame, and obtains a channel state H′_{1b}(82). The channel estimator 74 further refers to the second pilot signal included in the pilot portion 2 (200), and estimates the channel state H_{1b}(82) between the relay device 1 and the relay device 1b. In addition, the channel estimator 74 obtains the inverse characteristic H_{1b}⁻¹(82) of the channel state, and preserves the inverse characteristic H_{1b}⁻¹(82) of the channel state in the storage 122. The channel equalizer 71 obtains H′_{1b}⁻¹(82) which is the inverse characteristic of the above-described H′_{1b}(82), and performs the equalization to a payload portion 201 using the H′_{1b}⁻¹(82). The combiner 175 combines the new pilot portion 1 generated by the pilot signal generator 174 and the channel-equalizeed payload portion. The pre-equalizer 125 performs the pre-equalizing to the channel-equalizeed payload portion and the new pilot portion 1, using the inverse characteristic H₁ₐ⁻¹(72) of the channel state with the relay device 1a in the first period before the time t2, which is preserved in the storage 124. The pre-equalizing is performed before the transmission to the relay device 1b. The combiner 177 configures a new frame by inserting the pilot portion 2 generated by the pilot signal generator 176 between the pre-equalized pilot portion 1 and the pre-equalized payload portion. The controller 18 sets the transmission frequency of the transmitter 16 to 72 GHz at the time t2. Therefore, the transmitter 16 converts the baseband signal to the transmission frequency 72 GHz, and then transmits signals carrying the new frame from the antenna 17 to the relay device 1a.

As described above, the channel state is calculated by the pre-equalized pilot signal, and the inverse characteristic is obtained based on the calculated channel state. Then, the distortion of the signal is equalizeed for the similarly pre-equalized payload portion, using the information of the inverse characteristic. Further, the pilot signal and the equalizeed payload portion are pre-equalized using the inverse characteristic of the channel state obtained from the channel state obtained when the reception is previously performed from the same wireless communication device. Thus, the transmission characteristic of the relay can be further improved. For example, for the data to be carried, the effect that the SER (Symbol Error Rate) is reduced and the channel capacity increases simultaneously can be obtained. Thus, for the data carried by the radio waves relayed by the relay device, the efficient data transfer can be performed.

### Fifth Embodiment

A functional block diagram of the relay device as the wireless communication device according to the fifth embodiment is the same FIG. 16 as the fourth embodiment.

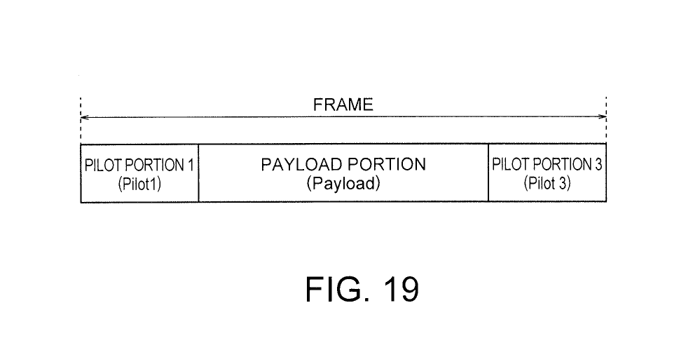

FIG. 19 is a diagram illustrating a format of the frame transmitted by the relay device according to the fifth embodiment. The frame according to the fifth embodiment includes the pilot portion 1 including the first pilot signal, the payload portion including the data, and a pilot portion 3 including a third pilot signal. By arranging the pilot portion 3 at the end of the frame, a newer condition of the channel can be reflected so that estimation accuracy of the channel state can be improved when the pre-equalizing is performed compared to the case of arranging the pilot portion 3 at the head of the frame.

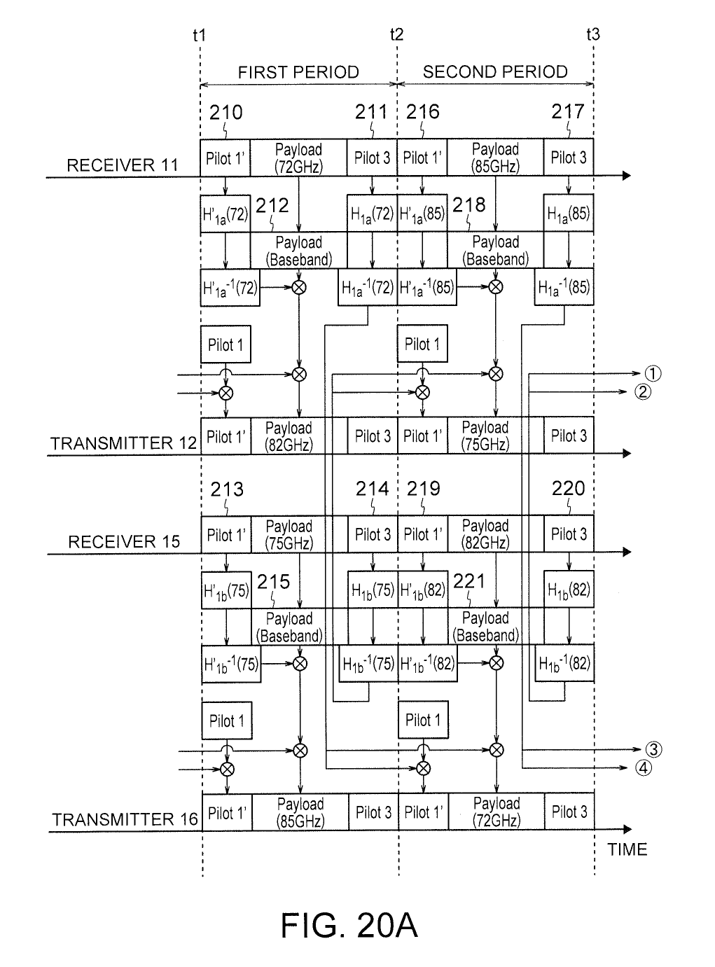

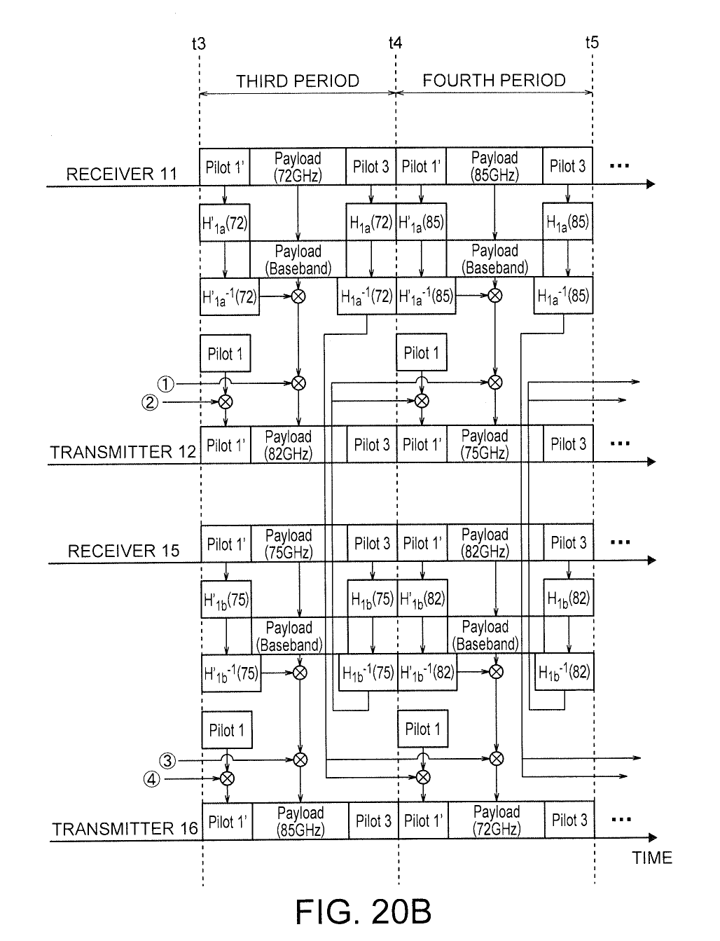

FIG. 20A and FIG. 20B are diagrams illustrating the processing performed to the frame by the relay device according to the fifth embodiment. The carrier frequency is switched respectively at the time t1, the time t2, the time t3, the time t4, and the time t5. The first period indicates the period between the time t1 and the time t2. The second period indicates the period between the time t2 and the time t3. The third period indicates the period between the time t3 and the time t4. The fourth period indicates the period between the time t4 and the time t5. In FIG. 20A and FIG. 20B, for the respective periods, an outline of the processing performed to the frame received by the relay device 1 is illustrated in the direction from top to bottom. Hereinafter, the processing performed for the frame will be described along FIG. 20A and FIG. 20B. Note that, in the figures, the pre-equalized pilot portion 1 is described as “Pilot1′” and the pilot portion 1 before being pre-equalized is described as “Pilot1”.

First, the processing for the first period will be described. At the time t1, the controller 18 sets the reception frequency of the receiver 11 to 72 GHz. The frame transmitted at the transmission frequency 72 GHz from the relay device 1a is received by the antenna 10, and converted to the intermediate frequency used by the baseband signal in the receiver 11. The channel estimator 70 refers to the first pilot signal included in the pilot portion 1 (210) of the received frame, and obtains the channel state H′₁ₐ(72). The channel estimator 70 further refers to the third pilot signal included in the pilot portion 3 (211), and estimates the channel state H₁ₐ(72) between the relay device 1 and the relay device 1a. In addition, the channel estimator 70 obtains the inverse characteristic H₁ₐ⁻¹(72) of the channel state, and preserves the inverse characteristic H₁ₐ⁻¹(72) of the channel state in the storage 124. The channel equalizer 71 obtains H′₁ₐ⁻¹(72) which is the inverse characteristic of the above-described H′₁ₐ(72), and performs the equalization to a payload portion 212 using the H′₁ₐ⁻¹(72). The combiner 171 combines the new pilot portion 1 generated by the pilot signal generator 170 and the channel-equalizeed payload portion. The pre-equalizer 123 performs the pre-equalizing to the channel-equalizeed payload portion and the new pilot portion 1, using the inverse characteristic H_{1b}⁻¹(82) of the channel state with the relay device 1b in the period before the time t1, which is preserved in the storage 122. The pre-equalizing is performed before the transmission to the relay device 1b.

The combiner 173 configures a new frame by combining the pilot portion 3 generated by the pilot signal generator 172 after the pre-equalized pilot portion 1 and the pre-equalized payload portion. The controller 18 sets the transmission frequency of the transmitter 12 to 82 GHz at the time t1. Therefore, the transmitter 12 converts the baseband signal to the transmission frequency 82 GHz, and then transmits signals carrying the new frame from the antenna 13 to the relay device 1b.

In the same first period, the processing for the frame received by the receiver 15 will be also described. At the time t1, the controller 18 sets the reception frequency of the receiver 15 to 75 GHz. The frame transmitted at the transmission frequency 75 GHz from the relay device 1b is received by the antenna 14, and converted to the intermediate frequency used by the baseband signal in the receiver 15. The channel estimator 74 refers to the first pilot signal included in the pilot portion 1 (213) of the received frame, and obtains the channel state H′_{1b}(75). The channel estimator 74 further refers to the third pilot signal included in the pilot portion 3 (214), and estimates the channel state H_{1b}(75). In addition, the channel estimator 74 obtains the inverse characteristic H_{1b}⁻¹(75) of the channel state, and preserves the inverse characteristic H_{1b}⁻¹(75) of the channel state in the storage 122. The channel equalizer 71 obtains the H′_{1b}⁻¹(75) which is the inverse characteristic of the above-described H′_{1b}(75), and performs the equalization to a payload portion 215 using the H′_{1b}⁻¹(75). The combiner 175 combines the new pilot portion 1 generated by the pilot signal generator 174 and the channel-equalizeed payload portion. The pre-equalizer 125 performs the pre-equalizing to the channel-equalizeed payload portion and the new pilot portion 1, using the inverse characteristic H₁ₐ⁻¹(85) of the channel state with the relay device 1a in the period before the time t1, which is preserved in the storage 124. The pre-equalizing is performed before the transmission to the relay device 1b. The combiner 177 configures a new frame by combining the pilot portion 3 generated by the pilot signal generator 176 after the pre-equalized pilot portion 1 and the pre-equalized payload portion. The controller 18 sets the transmission frequency of the transmitter 16 to 85 GHz at the time t1. Therefore, the transmitter 16 converts the baseband signal to the transmission frequency 85 GHz, and then transmits signals carrying the new frame from the antenna 17 to the relay device 1a.

Next, the processing in the second period will be described. At the time t2, the controller 18 sets the reception frequency of the receiver 11 to 85 GHz. The frame transmitted at the transmission frequency 85 GHz from the relay device 1a is received by the antenna 10, and converted to the intermediate frequency used by the baseband signal in the receiver 11. The channel estimator 70 refers to the first pilot signal included in the pilot portion 1 (216) of the received frame, and obtains the channel state H′₁ₐ(85). The channel estimator 70 further refers to the third pilot signal included in the pilot portion 3 (217), and estimates the channel state H₁ₐ(85). In addition, the channel estimator 70 obtains the inverse characteristic H₁ₐ⁻¹(85) of the channel state, and preserves the inverse characteristic H₁ₐ⁻¹(85) of the channel state in the storage 124. The channel equalizer 71 obtains H′₁ₐ⁻¹(85) which is the inverse characteristic of the above-described H′₁ₐ(85), and performs the equalization to a payload portion 215 using the H′₁ₐ⁻¹(85). The combiner 171 combines the new pilot portion 1 generated by the pilot signal generator 170 and the channel-equalizeed payload portion. The pre-equalizer 123 performs the pre-equalizing to the channel-equalizeed payload portion and the new pilot portion 1, using the inverse characteristic H_{1b}⁻¹(75) of the channel state with the relay device 1b in the first period before the time t2, which is preserved in the storage 122. The pre-equalizing is performed before the transmission to the relay device 1b. The combiner 173 configures a new frame by combining the pilot portion 3 generated by the pilot signal generator 172 to the pre-equalized pilot portion 1 and the pre-equalizeed payload portion. The controller 18 sets the transmission frequency of the transmitter 12 to 75 GHz at the time t2. Therefore, the transmitter 12 converts the baseband signal to the transmission frequency 75 GHz, and then transmits signals carrying the new frame from the antenna 13 to the relay device 1b.

In the same second period, the processing for the frame received by the receiver 15 will be also described. At the time t2, the controller 18 sets the reception frequency of the receiver 15 to 82 GHz. The frame transmitted at the transmission frequency 82 GHz from the relay device 1b is received by the antenna 14, and converted to the intermediate frequency used by the baseband signal in the receiver 15. The channel estimator 74 refers to the first pilot signal included in the pilot portion 1 (219) of the received frame, and obtains the channel state H′_{1b}(82). The channel estimator 74 further refers to the third pilot signal included in the pilot portion 3 (220), and estimates the channel state H_{1b}(82) between the relay device 1 and the relay device 1b. In addition, the channel estimator 74 obtains the inverse characteristic H_{1b}⁻¹(82) of the channel state, and preserves the inverse characteristic H_{1b}⁻¹(82) of the channel state in the storage 122. The channel equalizer 71 obtains H′_{1b}⁻¹(82) which is the inverse characteristic of the above-described H′_{1b}(82), and performs the equalization to a payload portion 221 using the H′_{1b}⁻¹(82). The combiner 175 combines the new pilot portion 1 generated by the pilot signal generator 174 and the channel-equalizeed payload portion. The pre-equalizer 125 performs the pre-equalizing to the channel-equalizeed payload portion and the new pilot portion 1, using the inverse characteristic H₁ₐ⁻¹(72) of the channel state with the relay device 1a in the first period before the time t2, which is preserved in the storage 124. The pre-equalizing is performed before the transmission to the relay device 1b. The combiner 177 configures a new frame by combining the pilot portion 3 generated by the pilot signal generator 176 to the pre-equalized pilot portion 1 and the pre-equalized payload portion. The controller 18 sets the transmission frequency of the transmitter 16 to 72 GHz at the time t2. Therefore, the transmitter 16 converts the baseband signal to the transmission frequency 72 GHz, and then transmits signals carrying the new frame from the antenna 17 to the relay device 1a.

As described above, by arranging the pilot portion (pilot portion 3) at the end of the frame, the pre-equalizing in consideration of the condition of the channel at a closer point of time is made possible. Thus, the effect of the fourth embodiment can be improved more.

### Sixth Embodiment

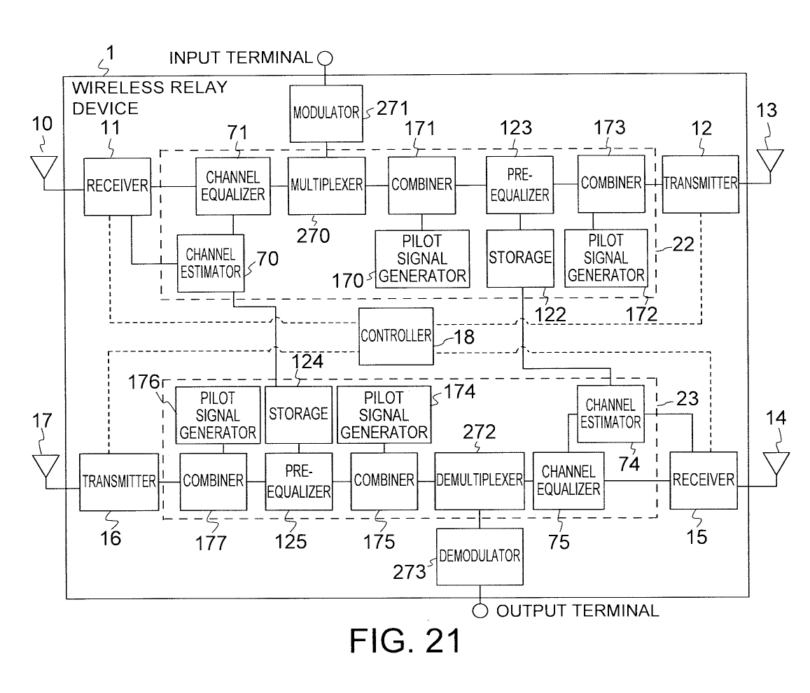

FIG. 21 is a functional block diagram of the relay device as the wireless communication device according to the sixth embodiment. The relay processor 22 according to the sixth embodiment includes the channel estimator 70, the channel equalizer 71, the storage 122, the pre-equalizer 123, the pilot signal generator 170, the combiner 171, the pilot signal generator 172, the combiner 173, and a multiplexer 270. Similarly, the relay processor 23 includes the channel estimator 74, the channel equalizer 75, the storage 124, the pre-equalizer 125, the pilot signal generator 174, the combiner 175, the pilot signal generator 176, the combiner 177, and a demultiplexer 272. The relay device according to the sixth embodiment further includes a modulator 271 provided with an input terminal, and a demodulator 273 provided with an output terminal. The modulator 271 is electrically connected to the multiplexer 270, and the demodulator 273 is electrically connected to the demodulator 273, respectively. The antenna 10, the receiver 11, the transmitter 12, the antenna 13, the antenna 14, the receiver 15, the transmitter 16, the antenna 17 and the controller 18 of the relay device according to the sixth embodiment have the functions respectively equivalent to that of the antenna 10, the receiver 11, the transmitter 12, the antenna 13, the antenna 14, the receiver 15, the transmitter 16, the antenna 17 and the controller 18 according to the first embodiment, respectively. In addition, the relay device according to the sixth embodiment also includes the local oscillator having the function equivalent to that of the local oscillator 20 and the local oscillator 21 of the relay device according to the first embodiment. At least one of the modulator 271 and the demodulator 273 may be realized by software by making a processor such as a CPU execute a program, may be realized by an exclusive hardware circuit or a programmable circuit, or may be realized by both.

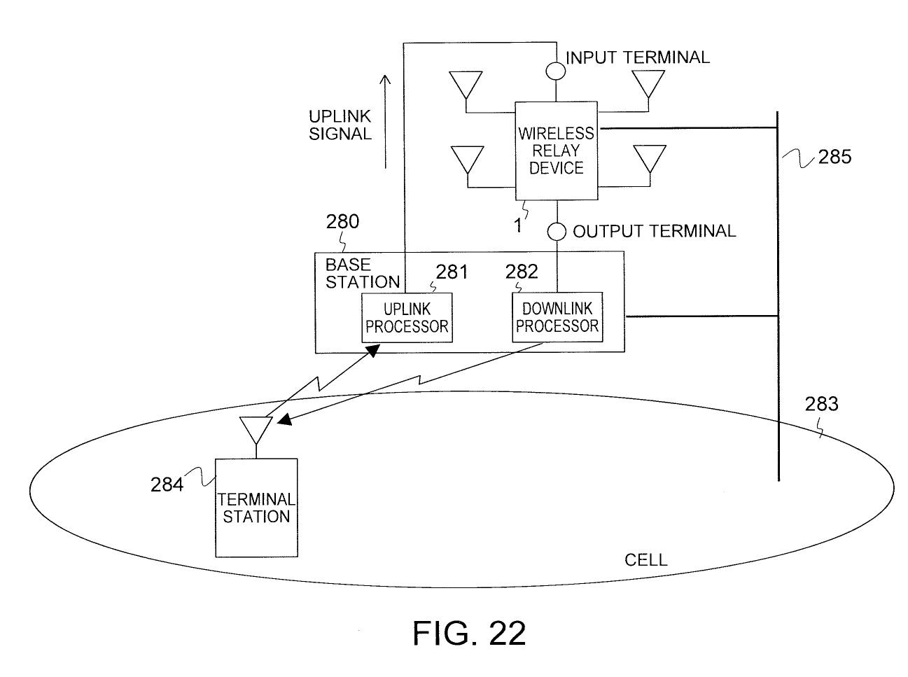

FIG. 22 illustrates an example of the wireless relay network according to the present embodiment. The wireless relay network includes the relay device 1 and a base station 280. The relay device 1 and the base station 280 are supported at an upper part of a region inside a cell 283 by a support member 285. The base station 280 can transmit and receive the data to/from a terminal station 284 positioned inside the cell 283. The input terminal of the relay device 1 is connected to an uplink processor 281 of the base station 280. The output terminal of the relay device 1 is connected to a downlink processor 282 of the base station 280. An uplink signal outputted from the uplink processor 281 of the base station 280 is inputted from the input terminal of the relay device 1 to the relay device 1. The uplink signal is modulated in the modulator 271 in FIG. 21, and then multiplexed to a relay signal in the multiplexer 270. At least one of the uplink processor 281 and the downlink processor 282 may be realized by software by making a processor such as a CPU execute a program, may be realized by an exclusive hardware circuit or a programmable circuit, or may be realized by both.

On the other hand, for a downlink, a range pertinent to a downlink signal is demultiplexed or duplicated in the demultiplexer 272 in FIG. 21 and delivered to the demodulator 273. The demodulator 273 demodulates the signal, and a demodulated downlink signal is outputted from the output terminal. The downlink signal is inputted to the downlink processor 282 of the base station 280. The downlink processor 282 executes downlink processing, and transmits a downlink signal to the terminal station 284. By connecting the relay device and the base station in this way, after multiplexing both of the uplink signal and the downlink signal of the plurality of base stations, the data can be relayed to a remote location outside the range of the cell 283 relating to the base station 280.

### Seventh Embodiment

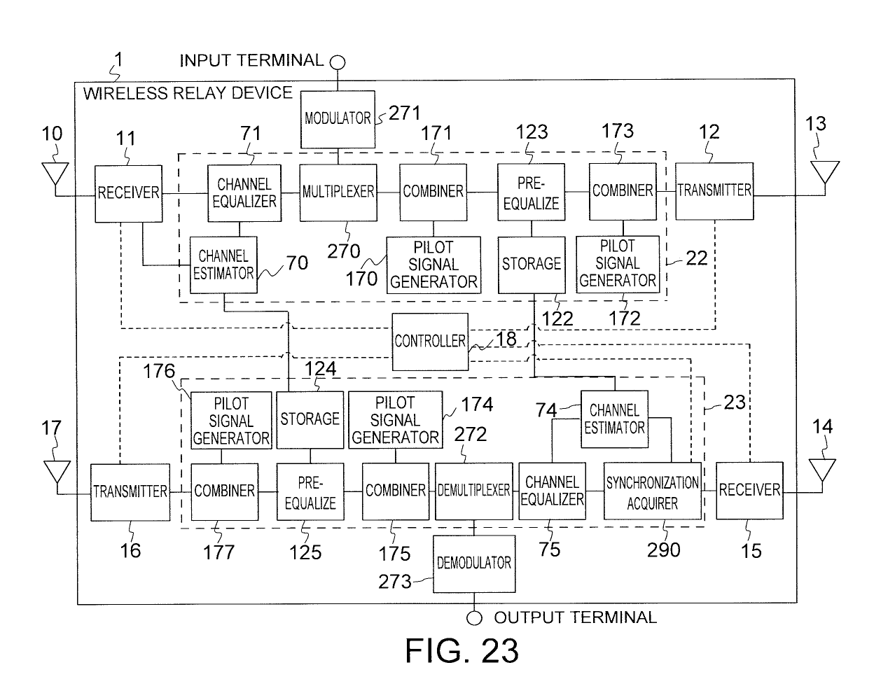

FIG. 23 is a functional block diagram of the relay device as the wireless communication device according to the seventh embodiment. The configuration of the relay processor 22 according to the seventh embodiment is similar to that of the sixth embodiment. The relay processor 23 is configured similarly to the relay processor 23 of the sixth embodiment, except for a point that a synchronization acquirer 290 is present. The antenna 10, the receiver 11, the transmitter 12, the antenna 13, the antenna 14, the receiver 15, the transmitter 16, the antenna 17, the controller 18, the modulator 271 and the demodulator 273 of the relay device according to the seventh embodiment have the functions respectively equivalent to that of the antenna 10, the receiver 11, the transmitter 12, the antenna 13, the antenna 14, the receiver 15, the transmitter 16, the antenna 17 and the controller 18 according to the first embodiment, and the modulator 271 and the demodulator 273 according to the sixth embodiment, respectively. In addition, the relay device according to the seventh embodiment also includes the local oscillator having the function equivalent to that of the local oscillator 20 and the local oscillator 21 of the relay device according to the first embodiment.

By the synchronization acquirer 290 in the seventh embodiment, the carrier frequency changeover timing of the relay device 1 can be synchronized with the other relay device or the wireless communication device. Specific processing of an operation of the synchronization acquirer 290 will be described below. The synchronization acquirer 290 refers to the pilot portion arranged at the head of the frame, acquires the synchronization using the processing of serial search or matched filtering or the like, and detects a frame boundary. The frame boundary detected by the synchronization acquirer 290 is notified to the controller 18. When a frame boundary detection notice is received, the controller 18 performs setting change to the respective parts of the local oscillator 20, the local oscillator 21, the receiver 11, the transmitter 12, the receiver 15 and the transmitter 16, and executes the changeover processing of the transmission frequency and the reception frequency. The carrier frequency changeover target may be either one of the transmission frequency and the reception frequency, or may be both of the transmission frequency and the reception frequency. The configuration and the method of the seventh embodiment are an example, and other configurations and methods may be used. For example, the method of successively receiving a specific frame for two or more times and then executing the changeover processing of the transmission frequency and the reception frequency may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless communication device comprising:
a first receiver;
a second transmitter;
a controller configured to switch a reception frequency of the first receiver from a first frequency to a second frequency and a transmission frequency of the first transmitter from the second frequency to the first frequency, at a first timing; and
a pre-equalizer configured to precode a second signal, based on channel state information of a first signal received in the first receiver before the first timing,
wherein the first transmitter transmits the pre-equalized second signal, after the first timing.

2. The wireless communication device according to claim 1, comprising:
a second receiver; and
a second transmitter,
wherein the controller switches a reception frequency of the second receiver from a third frequency to a fourth frequency and a transmission frequency of the second transmitter from the fourth frequency to the third frequency, at the first timing, and
wherein the second signal is a third signal received in the second receiver before the first timing.

3. The wireless communication device according to claim 2,
wherein the third frequency is same as the first frequency, and the fourth frequency is same as the second frequency.

4. The wireless communication device according to claim 2,
wherein the pre-equalizer pre-equalizes the first signal, based on the channel state information of the third signal, and
wherein the second transmitter transmits the pre-equalized first signal, after the first timing.

5. The wireless communication device according to claim 2,
wherein the first signal includes a first pilot signal, a pre-equalized second pilot signal, and a pre-equalized payload signal,
the wireless communication device comprises a channel equalizer configured to equalize the pre-equalized payload signal, based on the channel state information of the pre-equalized second pilot signal,
wherein the pre-equalizer pre-equalizes a third pilot signal and a second payload signal which is a equalizeed payload signal based on the channel state information of the third signal, and
wherein the second transmitter transmits a fourth signal including a pre-equalized third pilot signal, a pre-equalized second pilot signal, and a fourth pilot signal, after the first timing.

6. The wireless communication device according to claim 5,
wherein the fourth pilot signal is arranged after the pre-equalized third pilot signal and the pre-equalized payload signal.

7. The wireless communication device according to claim 1,
wherein the first signal includes a first pilot signal,
the wireless communication device comprises a channel estimator configured to acquire the channel state information of the first signal by performing channel estimation based on the first pilot signal.

8. The wireless communication device according to claim 1,
wherein the first transmitter transmits a fifth signal, the fifth signal including the pre-equalized second signal and a pilot signal for channel estimation.

9. The wireless communication device according to claim 1,
wherein the controller determines the first timing, based on the first signal.

10. The wireless communication device according to claim 2,
wherein the controller determines the first timing, based on a signal received in the second receiver.

11. The wireless communication device according to claim 1, comprising:
an input terminal configured to receive a fifth signal; and
a multiplexer configured to multiplex the fifth signal with the second signal,
wherein the equalizer pre-equalizes the second signal with which the fifth signal is multiplexed.

12. The wireless communication device according to claim 1, comprising:
a demultiplexer configured to demultiplex a sixth signal from the second signal; and
an output terminal configured to output the sixth signal,
wherein the equalizer pre-equalizes the second signal from which the sixth signal is demultiplexed.

13. The wireless communication device according to claim 1, further comprising at least one antenna coupled to the first receiver and the first transmitter.

14. The wireless communication device according to claim 2, further comprising at least one antenna coupled to the second receiver and the second transmitter.

15. A wireless communication method performed by a wireless communication device, comprising:
switching a reception frequency from a first frequency to a second frequency and a transmission frequency from the second frequency to the first frequency, at a first timing;
pre-equalizing a second signal, based on channel state information of a first signal received before the first timing; and
transmitting the pre-equalized second signal, after the first timing.
